(19) United States
(12) Patent Application Publication
(10) Pub. No.: US 2024/0190672 A1
(43) Pub. Date: Jun. 13, 2024

(54) METHODS AND APPARATUS TO MONITOR AND MANAGE LOADING DOCKS AND FACILITY OPERATIONS

(71) Applicant: Rite-Hite Holding Corporation, Milwaukee, WI (US)

(72) Inventors: James Boerger, Franksville, WI (US); Micaela Bomhack, Fox Point, WI (US); Timothy Kubly, Ixonia, WI (US); Richard Mews, Bonduel, WI (US); Moiz Neemuchwala, Milwaukee, WI (US)

(21) Appl. No.: 18/533,590

(22) Filed: Dec. 8, 2023

Related U.S. Application Data
(60) Provisional application No. 63/386,620, filed on Dec. 8, 2022.

(51) Int. Cl. B65G 69/28; B65G 69/00

(52) U.S. Cl. CPC B65G 69/2882; B65G 69/003; B65G 69/2864

(57) ABSTRACT

Methods, apparatus, systems, and articles of manufacture to monitor and manage loading docks and facility operations are disclosed. An example apparatus includes processor circuitry to: identify a first occurrence of a safety event based on outputs of sensors associated with at least one of doors or docks, the event associated with a first event type of a plurality of event types; determine a time of day different instances of the event occurred within a given period of time; determine a number of at least one of different doors or different docks associated with the different instances of the event; select a particular corrective action based on the time of day of the different instances of the event and based on the number of the at least one of the different doors or the different docks; and cause an output device to output an indication of the particular corrective action.

### RELATED APPLICATION(S)

This patent claims the benefit of U.S. Provisional Patent Application No. 63/386,620, which was filed on Dec. 8, 2022. U.S. Provisional Patent Application No. 63/386,620 is hereby incorporated herein by reference in its entirety. Priority to U.S. Provisional Patent Application No. 63/386,620 is hereby claimed.

### FIELD OF THE DISCLOSURE

This disclosure relates generally to monitoring systems and, more particularly, to methods and apparatus to monitor and manage loading docks and facility operations.

### BACKGROUND

Loading docks provide an area for vehicles (e.g., trucks, trailers, etc.) to move next to an elevated platform of a building (e.g., a material handling facility) so that cargo can be readily transferred between the vehicle and the building. Some loading docks include equipment such as dock levelers, vehicle restraints, and/or dock doors, any of which may be associated with one or more sensor/monitoring systems. Within material handling facilities there may be additional equipment to facilitate the movement, storage, and/or handling of cargo such as, for example, grade-level doors, HVAC (heating, ventilation, and air conditioning) systems, industrial doors to partition freezer rooms and/or other rooms, conveyor systems, fans for air movement within the facility, lighting and signal systems, etc.

### BRIEF DESCRIPTION OF THE DRAWINGS

FIG. 1 illustrates an example material handling facility in which teachings disclosed herein may be implemented.

FIG. 2 illustrates the example loading dock of FIG. 1 viewed from an exterior of the material handling facility.

FIG. 3 illustrates the example loading dock of FIG. 1 viewed from an interior of the material handling facility with a trailer parked at the dock.

FIG. 4 is a cross-sectional side view of the example loading dock of FIG. 1 with the associated trailer of FIG. 3.

FIGS. 5-10 illustrate example graphical user interfaces that may be generated by the main server of FIG. 1.

FIG. 11 is a block diagram of an example implementation of the example main server of FIG. 1.

FIGS. 12 and 13 are flowcharts representative of example machine readable instructions which may be executed to implement the example main server of FIGS. 1 and/or 11.

FIG. 14 is a block diagram of an example processing platform including processor circuitry structured to execute the example machine readable instructions and/or the example operations of FIGS. 12 and 13 to implement the main server of FIGS. 1 and/or 11.

FIG. 15 is a block diagram of an example implementation of the processor circuitry of FIG. 14.

FIG. 16 is a block diagram of another example implementation of the processor circuitry of FIG. 14.

FIG. 17 is a block diagram of an example software distribution platform (e.g., one or more servers) to distribute software (e.g., software corresponding to the example machine readable instructions of FIGS. 12 and 13) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for case of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

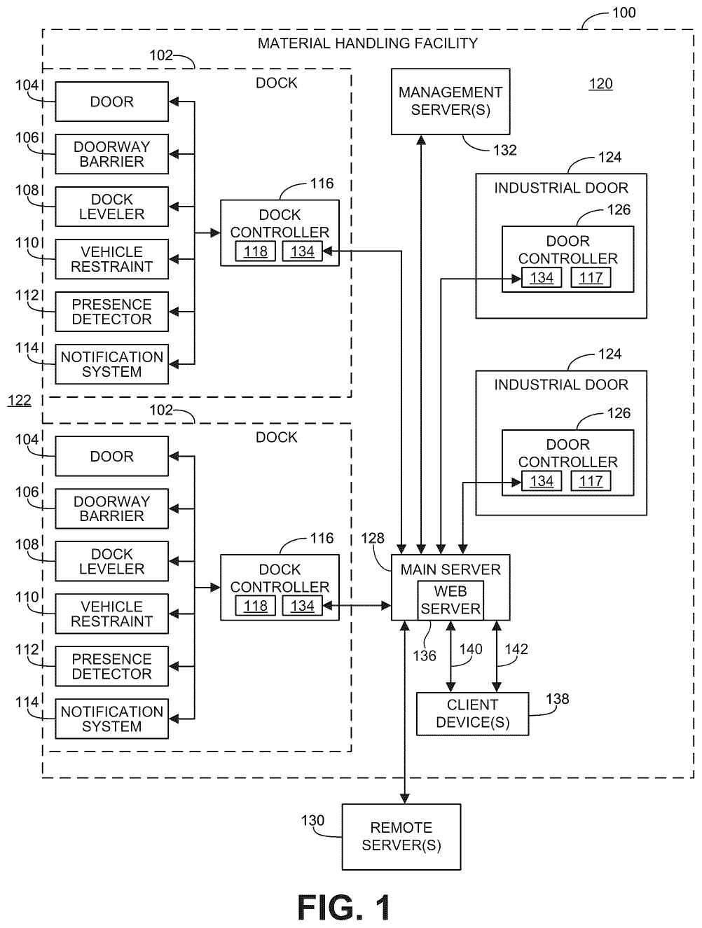

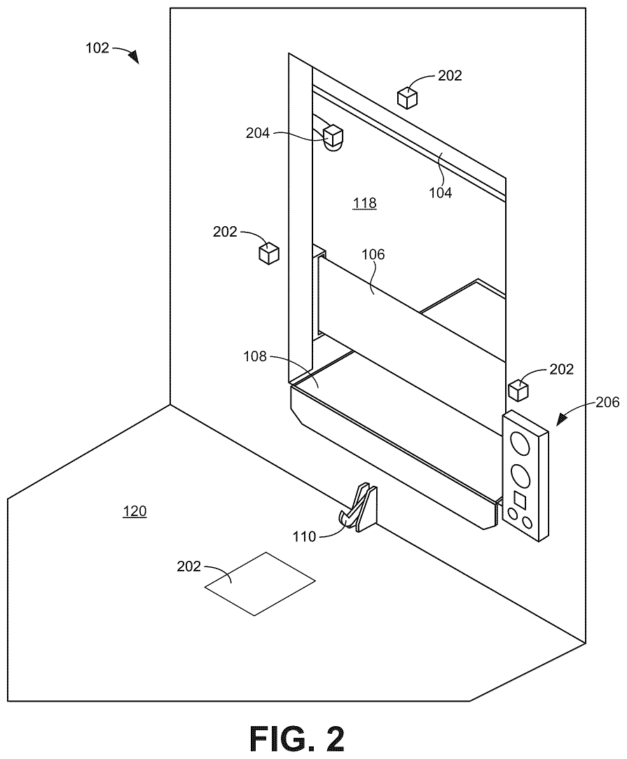

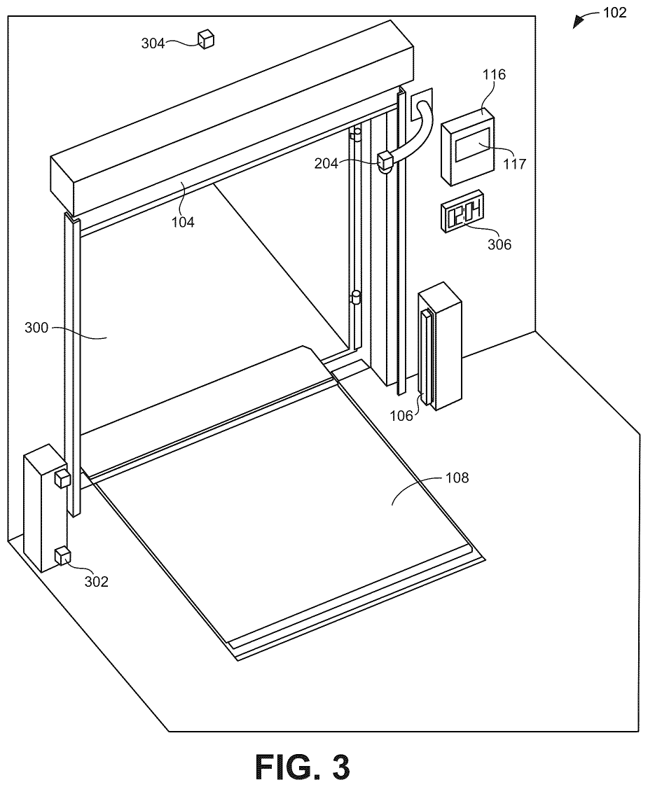

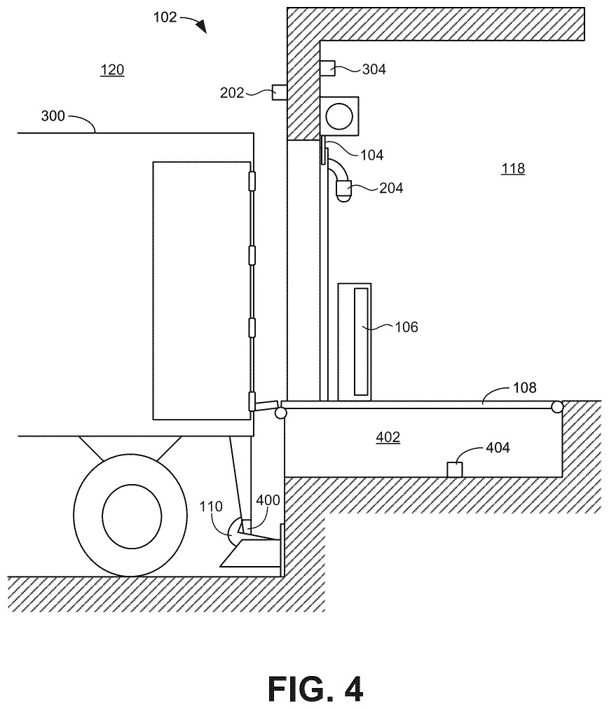

FIG. 1 illustrates an example material handling facility 100 in which teachings disclosed herein may be implemented. The material handling facility 100 may be associated with, for example, a storage warehouse, a distribution center, a manufacturing plant, a retail store, etc. In the illustrated example, the material handling facility 100 includes a plurality of loading docks 102 (two are shown) providing platforms for trucks to back up a trailer or truck bed (both of which are referred to herein as a trailer) to enable the loading and/or unloading of materials between the inside of the trailer and the material handling facility 100. FIG. 2 illustrates an example loading dock 102 viewed from an exterior of the material handling facility 100. FIG. 3 illustrates the example loading dock 102 viewed from an interior of the material handling facility 100 with a trailer 300 parked at the dock 102. FIG. 4 illustrates a cross-sectional side view of the example loading dock 102 with the associated trailer 300. As shown in FIGS. 1-4, the example dock 102 includes a door 104, a doorway barrier 106, a dock leveler 108, a vehicle restraint 110, a presence/motion detector 112, and/or a notification system 114. In some examples, the docks 102 may be associated with and/or include other equipment such as, for example, fans, lights, door seals, shelters, trailer stands, etc.

In the illustrated example, each of the docks 102 include a dock controller 116 to monitor and/or control the operation of the corresponding door 104, the corresponding doorway barrier 106, the corresponding dock leveler 108, the corresponding vehicle restraint 110, the corresponding presence/motion detector 112, the corresponding notification system 114 and/or other equipment associated with the dock. In some examples, the dock controller 116 includes a display screen 118 to display information associated with the components being monitored and/or controlled by the controller 116. The display screen 118 may be a touchscreen in which a user may also input commands and/or instructions to operate the controller and/or access specific information associated with the controller, the dock, or the operations involving the dock. In some examples, the display screen 118 may be incorporated into a different device that is separate from but in communication with the dock controller 116. Although a single controller 116 is shown as controlling all equipment associated with the dock 102, in some examples, each dock 102 may be associated with multiple controllers configured to control and/or monitor different ones of the door 104, the doorway barrier 106, the dock leveler 108, the vehicle restraint 110, the presence/motion detector 112, the notification system 114 and/or other equipment associated with the dock. In other examples, a dock controller 116 may be associated with more than one dock and, thus, able to control more than one aspect and/or function of two or more docks.

The doors 104 associated with the docks 102 are moveable between open and closed positions to selectively unblock or close off a doorway between an interior 120 of the material handling facility 100 and an exterior environment 122. Thus, when the trailer 300 is parked at the dock 102, the door 104 provides access to the trailer when the door 104 is in the open position and prevents such access when in the closed position.

In some examples, the doors 104 are associated with one or more sensors and/or door monitoring systems to facilitate the monitoring and/or control of the operation of the doors 104. For example, one or more door status sensors may monitor and/or detect a status of the door 104 (e.g., whether the door is fully open, fully closed, partially open, partially closed, opening, or closing); one or more impact sensors may monitor and/or detect when the door 104 has been struck (e.g., by a material handling vehicle (e.g., a forklift)); one or more photoelectric eyes arranged on either side of the door 104 may monitor and/or detect the passage of a person or object through the doorway when the door is open; one or more motion and/or presence sensors may monitor and/or detect activity in an area proximate the doorway (e.g., in the material handling facility 100 and/or in the trailer 300); one or more radio frequency identification (RFID) sensors may monitor and/or detect the identity of personnel, equipment, and/or material passing through the doorway; one or more temperature sensors may monitor and/or detect the temperature on one or both sides of the door 104; one or more airflow sensors may monitor and/or detect the flow of air passing the door 104 (e.g., air passing through the door when in an open or partially open position and/or air leaking passed the door when in the closed position closed); one or more other environmental sensors may monitor and/or detect pressure, humidity, pollutants, particulates, chemicals, etc.; one or more actuator sensors may monitor and/or detect the energy consumption and/or operation of a door actuator (e.g., a motor) used to open and/or close the door; and one or more image and/or video sensors (e.g., a camera) may be implemented to monitor and/or detect particular states of the dock based on image/video analysis. In some examples, the dock controller 116 receives output signals from these sensors to monitor and/or control the operation of the door 104.

In some examples, the doorway barrier 106 is constructed to provide a barrier that extends across the doorway associated with the door 104. The doorway barrier 106 may block passage through the doorway even when the door 104 is in the open position. The doorway barrier 106 may be used in this manner as a safety precaution when, for example, the door 104 is open but there is no trailer parked at the dock 102 as shown in FIG. 2 or when a trailer at the dock 102 is not restrained. The doorway barrier 106 may also extend across the doorway in front of the door 104 within the interior 120 of the material handling facility 100 when the door 104 is closed to protect the door 104 by reducing the likelihood of material handling equipment colliding with the door 104. In some examples, the doorway barrier 106 is associated with a barrier sensor 302 (FIG. 3) that outputs a signal to the dock controller 116 to indicate a status of the doorway barrier 106 (e.g., whether the barrier is in active use and blocking the doorway (as shown in FIG. 2), stowed away to provide passage through the doorway (as shown in FIGS. 3 and 4), or in some intermediate state). In some examples, the barrier sensor 302 and/or a different sensor detects an impact (e.g., a force) on the barrier 106 that may indicate a collision with the barrier.

Often, when a truck bed or trailer (e.g., the trailer 300 shown in FIGS. 3 and 4) is parked at the dock 102, there may be a gap between the rear edge of the truck bed or trailer and the outside face of the platform of the dock 102. The dock leveler 108 provides an adjustable bridge to span this gap over which material handling equipment can travel between the interior 120 of the material handling facility 100 and the trailer of the vehicle parked at the dock 102. Furthermore, the dock leveler 108 may be vertically adjustable to act as a ramp that accounts for trailers that have different heights relative to the platform of the dock 102. In some examples, the dock leveler 108 includes one or more sensors to facilitate the monitoring and control of the operation of the dock leveler 108. For example, a leveler sensor may produce an output signal indicative of when the dock leveler 108 is in an active state (extended to bridge the gap between the dock platform and a trailer as shown in FIGS. 3 and 4), an inactive state (when the leveler is in a stored position as shown in FIG. 2), or in some intermediate state. In some examples, a trailer being pulled away from the dock 102 while the dock leveler 108 is in an active state is detected by a sensor such as a limit switch (e.g., detecting the leveler dropping when the extended end is no longer supported by the trailer). In such examples, an output of the limit switch may trigger the dock controller 116 to cause the dock leveler 108 to retract to the stored position of the inactive state.

The vehicle restraint 110 associated with each dock 102 is positioned in the exterior environment 122 to engage some part of the vehicle (e.g., the trailer 300) parked at the dock 102 to reduce inadvertent movement of the vehicle (e.g., by the vehicle shifting as a result of material handling equipment moving around within the trailer and/or by a driver prematurely driving away from the platform). In some examples, the vehicle restraint 110 engages a rear impact guard (e.g., an ICC bar 400 as shown in FIG. 4) of the vehicle to restrain the vehicle. In some examples, the vehicle restraint 110 engages a tire and/or any other suitable portion of the vehicle. In some examples, the vehicle restraint 110 includes a trailer stand (e.g., that engages and/or supported an underside of a trailer of the vehicle). In some examples, the vehicle restraint 110 includes one or more sensors to facilitate the monitoring and/or control of the operation of the vehicle restraint 110. For example, a restraint sensor may produce an output signal indicative of when the vehicle restraint 110 is in a locked position (e.g., in position to engage/restrain the vehicle) or an unlocked position (e.g., stored away from the vehicle). Alternatively or in addition, the restraint sensor(s) may produce an output signal indicative of the position of the restraint relative to a reference point and/or the force(s) experienced by the restraint to determine if the restraint is actively engaged/restraining the vehicle or not.

In the illustrated example of FIG. 1, the presence/motion detector 112 represents one or more presence and/or motion detector systems. In some examples, the presence/motion detector 112 includes a presence detector system to detect the presence of the trailer 300 located at the dock 102. The term “trailer” for purposes of discussion related to sensing presence or motion, pertains to a trailer which may or may not be connected and/or disconnected to/from a tractor or alternatively pertains to a vehicle with a cargo bay or platform. In some examples, the presence of the trailer 300 is detected via one or more trailer sensors 202 (FIG. 2) positioned in the exterior environment 122 either on and/or adjacent the building of the material handling facility 100. The trailer sensor(s) 202 may be implemented using any suitable sensors such as, for example, photoelectric eyes, proximity sensors, motion sensors, inductive loop sensors, a light detection and ranging (LIDAR) system, a camera running analytics, etc. In some examples, the presence/motion detector 112 may include a presence detector system to detect the presence of personnel/equipment (e.g., people on foot and/or driving material handling equipment, autonomous vehicles, etc.) within a trailer 300 parked at the loading dock 102 (e.g., loading and/or unloading cargo) or outside the facility on the approach of the dock 102. In some examples, the presence of personnel/equipment within the trailer 300 is detected based on a motion sensor 204 (FIGS. 2-4) facing into the trailer from a position within the material handling facility 100. Additionally or alternatively, the presence/motion detector 112 may include a presence detector system to detect the presence of personnel/equipment/materials on the platform of the leveler 108, in the leveler pit 402, and/or otherwise in close proximity to the dock 102. In some examples, the presence of personnel/equipment within the material handling facility 100 in proximity to the dock 102 is detected based on motion sensors 304 (FIGS. 3 and 4) facing the leveler 108 and/or surrounding area. Additionally or alternatively, the presence of personnel/equipment/materials may be detected within a leveler pit 402 (FIG. 4) underneath the dock leveler 108 (e.g., for levelers stored in a vertically upright position) based on one or more presence/motion sensors 404 within the leveler pit 402. In addition to detecting the presence of vehicles, personnel, or material handling equipment, any one of the presence/motion systems represented by the presence/motion detector 112 of FIG. 1 may be enabled to determine the movement (e.g., speed, direction, etc.), the position (e.g., proximity, orientation, etc.), the size, the shape, etc. and combinations thereof of vehicles, personnel, equipment, or other things (e.g., product, materials) and may be capable of differentiating between these things.

The notification system 114 of the illustrated example may include multiple separately functioning notification systems that include one or more visual indicators (e.g., lights, display screens, etc.) and/or one or more audible indicators (e.g., horns, bells, sirens, speakers, etc.) to inform personnel near the docks 102 of particular circumstances, warnings, events, and/or other conditions associated with some aspect or status of the dock 102 and/or the vehicle located at the dock. Additionally or alternatively, some of the visual indicators may be lights intended to illuminate and/or improve visibility of areas associated with the docks 102 without indicating any particular circumstance or condition associated with the docks. The visual and/or audible indicators of the notification system 114 may be located within the interior 120 of the material handling facility 100 and/or located in the exterior environment 122 outside of the material handling facility 100 depending on the purpose of the indicators.

In some examples, at least some indicators within the material handling facility are positioned and/or oriented towards the exterior environment 122 (e.g., on the end of the arm associated with the motion sensor 204 shown in FIGS. 2-4) to illuminate, be visible from, and/or heard from within an interior of a trailer parked at the dock 102 when the door 104 is open. Such indicators may provide greater visibility to personnel entering the trailer to load and/or remove cargo. Such indicators may also warn personnel within the trailer of potential safety risks such as the vehicle restraint 110 not being engaged and/or of the presence of people near the platform of the dock 102 that may not be visible from within the trailer. Other indicators within the material handling facility 100 may be positioned and/or oriented to illuminate, be visible from, and/or heard from areas within the interior 120 of the facility (e.g., at the dock platform and/or surrounding area). Some such indicators may serve as warnings of potential safety risks such as, for example, the vehicle restraint 110 not being engaged and/or of the presence of someone in the trailer that may be about to come out unexpectedly. Additionally or alternatively, the indicators may indicate the operational state of equipment associated with the dock 102.

In some examples, the notification system 114 of FIG. 1 includes a timing indicator 306 (FIG. 3) positioned adjacent the door 104 that is visible from within the material handling facility 100 to display a timer indicating how long a trailer has been parked at the dock 102. In this manner, personnel may be informed of how much time is left until detention and/or demurrage charges begin to accrue. In some examples, the timing indicator 306 is implemented via the display screen 118 associated with the dock controller 116. In some examples, the timing indicator 306 may countdown instead of counting up. In some examples, the timing indicator 306 may change appearance (e.g., change color, begin flashing, etc.) and/or another indicator may be activated when the timing indicator reaches a threshold to indicate to personnel the near expiration of time related to a particular operational constraint (e.g., the need to quickly finish loading and/or unloading the trailer). In some examples, the timing indicator 306 may indicate (e.g., based on a color, flashing, etc.) a priority for loading and/or unloading a trailer at the corresponding dock 102 relative to the loading and/or unloading of other trailers at other docks 102. In some such examples, the prioritization may be based on predicted time allocation and/or predicted cost incursion across multiple docks 102 of the material handling facility 100 in light of available operational resources (e.g., personnel on hand, available material handling equipment, pick status, cross dock order status, etc.). Although the timing indicator 306 is shown as being distinct and spaced apart from the controller 116 in the illustrated examples, in other examples, the controller 116 includes the timing indicator 306.

In some examples, one or more indicators are positioned on the outside of the material handling facility 100 to illuminate, be visible from, and/or heard from areas external to the docks 102. In some examples, such indicators may be lights that illuminate the area to provide greater visibility for people in the exterior environment 122 (e.g., a driver backing a trailer up to the dock 102). Additionally or alternatively, in some examples, the indicators may be lights that provide warnings and/or guidance to people in the exterior environment 122. For example, as shown in FIG. 2, light indicators 206 on the exterior of the facility 100 include a stop (red) and go (green) light to direct a truck driver when a trailer (e.g., the trailer 300 of FIGS. 3 and 4) may be backed into the area adjacent the dock 102 and/or when the trailer may be pulled away from the dock 102. In some examples, light and/or audible indicators can be used to indicate to a driver when the vehicle restraint 110 is in override (e.g., not being used because the shape and/or construction of the trailer prevents the restraint 110 from engaging and/or restraining the trailer), dock equipment is undergoing maintenance, or there is someone/something in or near the path of the trailer, etc. These conditions may be communicated via separate indicators, utilizing different states of a common indicator (color/tone change, flashing/sounding pattern, etc.) or combinations thereof. Further, in some examples, indicators associated with the dock 102 include lights and/or audible alarms indicating to people standing near the dock approach when a truck is backing in.

In some examples, the dock controller 116 controls the different indicators associated with the notification system 114 based on one or more of the signals received from the various sensors associated with the door 104, the doorway barrier 106, the dock leveler 108, the vehicle restraint 110, and/or the presence detector 112. For instance, in some such examples, the dock controller 116 causes the light indicators 206 to provide a stop light (e.g., a red light) whenever the restraint signal indicates that the vehicle restraint 110 is active and engaged with the trailer. As another example, if the door sensor indicates the door 104 is opened when the presence detector 112 fails to detect a trailer parked at the dock 102, there is a risk that the open door may lead to a drop-off of the dock platform. Accordingly, in some such examples, the dock controller 116 may turn on a warning indicator to caution nearby individuals of the exposed drop. However, in some such examples, the dock controller 116 may not trigger the warning indicator when the barrier sensor 302 provides a signal indicating the doorway barrier 106 is in active use to block passage through the opened doorway. Thus, different signals output from different ones of the various sensors may be used in combination to trigger a change in the activation or state of indicators associated with the notification system 114 to provide warnings, notifications, and/or guidance to people in areas associated with the dock 102.

While the material handling facility 100 includes the docks 102 with various components and/or systems to facilitate the transfer of goods between a trailer and the material handling facility 100, the material handling facility 100 of FIG. 1 also includes other components and/or systems that facilitate the handling, movement, and/or storage of goods within the interior 120 of the material handling facility 100. In some examples, these components and/or systems may operate substantially independent of one another with separate controllers to monitor and/or control their operation. In particular, as shown in FIG. 1, the material handling facility 100 includes one or more industrial doors 124 (two are shown) that are power to selectively block and unblock doorways and/or other passageways between different locations (e.g., rooms and/or other areas) within the material handling facility 100.

In the illustrated example, each door 124 includes a corresponding door controller 126 to control the operation of the door 124. In some examples, the industrial doors 124 also include sensors similar to or the same as those described above (for the doors 104 at the loading docks 102) to enable the door controllers 126 to monitor and/or control the internal doors 124. For example, such doors 124 may include one or more door status sensors that indicate a status of the door 124 (e.g., open, closed, opening, closing, etc.); one or more impact sensors that monitor and/or detect when the door has been impacted, such as when a material handling vehicle has struck the door 124; one or more sensors, such as photoelectric eyes that monitor and/or detect the passage of a person or object through a doorway associated with the door 124; one or more motion and/or presence sensors that monitor and/or detect activity in an area proximate the doorway (e.g., on one or both sides of the doorway); one or more RFID sensors that monitor and/or detect the identity of personnel, equipment, and/or material passing through the doorway; one or more temperature sensors that monitor and/or detect the temperature on one or both sides of the door 124; one or more other environmental sensors that monitor and/or detect pressure, humidity, pollutants, particulates, chemicals, etc.; one or more airflow sensors that monitor and/or detect the flow of air passing the door 124 (e.g., air passing the door 124 when in an open or partially open position and/or air leaking passed the door 124 when in the closed position closed); and one or more actuator sensors that monitor and/or detect the energy consumption and/or operation of a door actuator (e.g., a motor) used to open and/or close the door 124. Additionally or alternatively, in some examples the door 124 includes one or more breakaway sensors to detect a breakaway event. As used herein, a breakaway event is when a door panel of an example door 124 is forced out of tracks guiding lateral edges of the door panel. Typically, breakaway events are caused by an impact with the door panel by a relatively large object (e.g., a forklift). However, breakaway events can be caused by a pressure blowout. In some examples, the door controller 126 includes and/or is communicatively coupled to a local display screen similar to the display screen 118 of the dock controller 116.

In some examples, how the door controller 126 uses signals output by such sensors may depend on the location and/or intended use of the associated door 124. For example, one or more doors 124 may provide access to a freezer room. In such examples, the associated door controller 126 may monitor a feedback signal provided by a temperature sensor to ensure the temperature on the freezer side of the room remains at or below a temperature set point. Additionally or alternatively, the door controller 126 for a freezer door may monitor how frequently and/or how long the door is opened (based on feedback from the door status sensor) and generate alerts when the frequency or duration of the door being open exceeds corresponding thresholds. In other examples, one or more doors 124 may be used to control access to a cleanroom with a relatively low level of pollutants. In some such examples, the door controller 126 may monitor feedback signals from one or more airflow and/or pressure sensors to ensure the amount of airflow (potentially leading to the spread of contaminants) is maintained at or below a suitable threshold or that a certain pressure differential is maintained across the doorway. In some examples, separate doors (e.g., the industrial doors 124 and/or the dock doors 104) may be configured according to an interlock relationship such that the operation of one door is conditioned on the state or operation of a second door (e.g., only one of two doors may be opened at any given point in time). In such examples, signals from sensors monitoring the operation of each door may be provided to separate door controllers 116, 126 associated with each door (or a single controller 116, 126 that controls both doors).

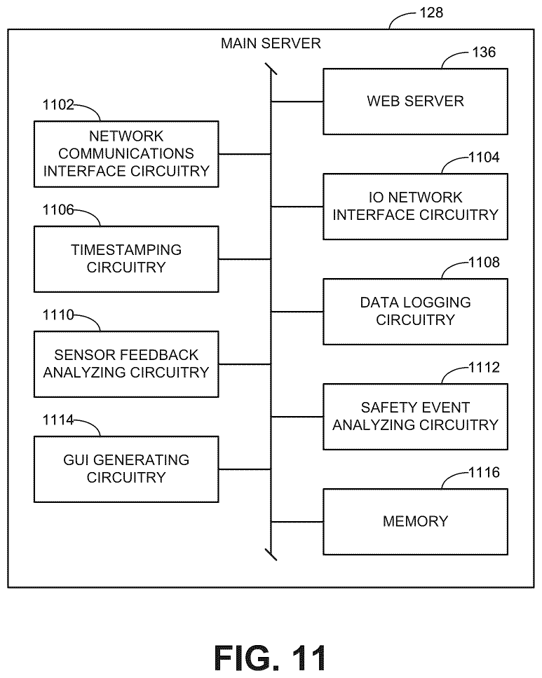

In the illustrated example of FIG. 1, each of the dock controllers 116 associated with the different docks 102 and the door controllers 126 associated with internal industrial doors 124 communicates with a main server 128. More particularly, in some examples, the dock controllers 116 and the door controllers 126 transmit values corresponding to the operational and/or state parameters configured in the respective controllers 116, 126 and/or feedback signals collected from any sensors associated with the respective controllers. In this manner, the main server 128 aggregates all available data associated with the various and separate systems in the material handling facility 100 into one place. The aggregation of data from the disparate sources enables the main server 128 to analyze and/or integrate the controller data to identify relationships that would not otherwise be possible to identify. As described more fully below, in some examples, the main server 128 organizes the aggregated controller data for presentation to end users via one or more dashboards or graphical user interfaces (GUIs) directed to particular interests of the end users. The graphical user interfaces may be presented by one or more web pages, apps, applets, applications, etc. In some examples, the graphical user interfaces may be configurable to provide notifications and/or alerts when particular events are detected based on the values of a combination of different parameters monitored by one or more of the controllers 116, 126. Further detail regarding the implementation of the example main server 128 is provided below in connection with FIGS. 11-13. Additionally or alternatively, in some examples, the main server 128 may transmit information back to the controllers 116, 126. In some such examples, information transmitted to the controllers is passive in that it does not affect the operation of the components controlled by the controllers. In such examples, the information may be provided to be displayed on a local display screen (e.g., the display screen 118 of the dock controller 116 shown in FIG. 3 and/or a similar local display screen associated with one of the door controllers 126) to be referenced by personnel positioned near the controllers. In other examples, the information transmitted to the controllers from the main server 128 may be active in that it includes commands causing the controllers to implement certain operations. Although the main server 128 is shown as being located within the material handling facility 100 in the illustrated example, in other examples, the main server 128 may be remotely located away from the material handling facility 100. In some examples, the main server 128 may be integrated with and/or implemented by one of the dock controllers 116. In some examples, the main server 128 may be located in the cloud (e.g., may be a server provided by a cloud provider).

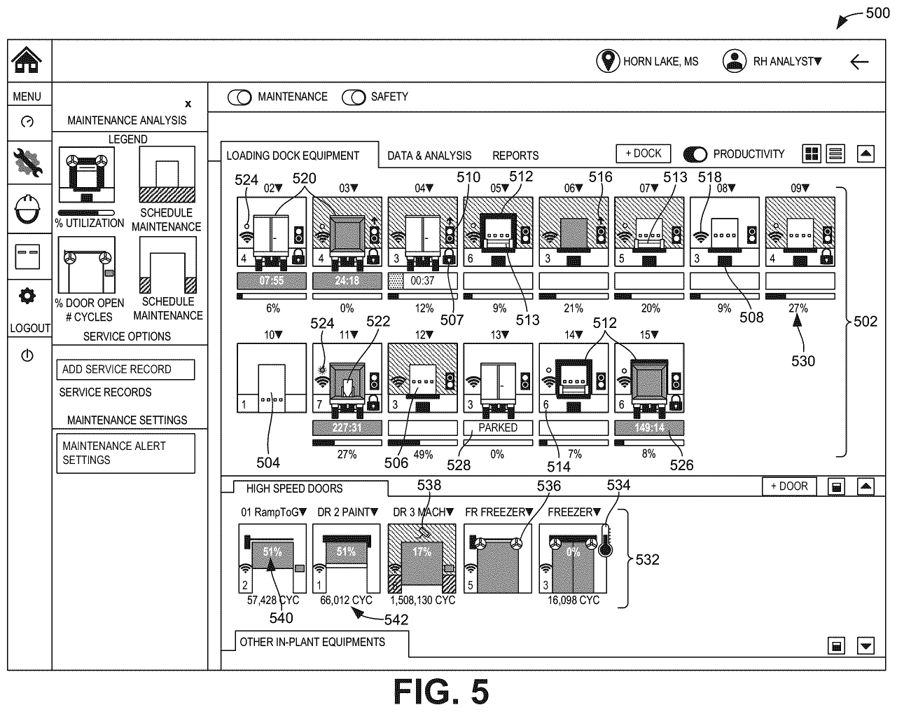

In some examples, the graphical user interfaces generated based on information aggregated by the main server 128 may be configurable to provide substantially real-time (e.g., less than a 5 second delay) information regarding the configurations, operations, and/or current states of one or more of the docks 102 and/or doors 124. Further, the graphical user interfaces can also provide alerts and/or notifications of detected safety events and/or the need to schedule maintenance equipment in the facility. In some examples, safety events across different equipment (e.g., different docks 102 and/or doors 124) can be aggregated and categorized based on the type of safety event, the time of day the events occurred, and/or the equipment involved to assess the frequency and nature of the safety events. In some examples, depending on the nature of the safety events, the main server 128 can generate different recommendations for corrective actions that may be provided through the graphical user interfaces. Example graphical user interfaces and the way recommended corrective actions and other safety analysis information is provided to a user are discussed further below in connection with FIGS. 5-10.

In the illustrated example of FIG. 1, the main server 128 communicates with one or more remote server(s) 130 that are not located at the material handling facility 100. In some examples, the remote server(s) 130 correspond to additional servers, comparable to the main server 128, that are located at other material handling facilities and/or other locations associated with the business enterprise operating the material handling facility 100 of FIG. 1. Additionally or alternatively, in some examples, the remote server(s) 130 may correspond to a server maintained by a manufacturer of equipment associated with one or more of the dock controllers 116 and/or the door controllers 126. For example, the remote server 130 may provide equipment warranty information, equipment version and/or update information, equipment installation dates, records of technician and/or service calls, etc. In other examples, the remote server 130 may be located in the cloud (e.g., may be a server provided by a cloud provider).

In the illustrated example of FIG. 1, the material handling facility 100 includes one or more management server(s) 132 that facilitate the management of various aspects of the equipment assets and/or working operations of the material handling facility 100. In some examples, the management server(s) 132 communicate with the main server 128 via a bus, local area network (LAN), and/or a wide area network (e.g., the Internet). The example management server(s) 132 may include a dock/yard management system, an inventory control system, a video management system (VMS), a warehouse management system (WMS), an enterprise resource planning (ERP) system, etc. Additionally or alternatively, in some examples, one or more of the management servers 132 may be combined with and/or implemented by the main server 128.

For purposes of explanation, the data reported to the main server 128 from the different controllers 116, 126 of FIG. 1 is referred to herein as IO (input/output) data because it includes the inputs and outputs monitored and/or provided by the respective controllers. The IO data is also referred to herein as sensor feedback data because the IO data is based on feedback from sensors collected by the different controllers 116, 126. In the illustrated example, the IO data (sensor feedback data) collected by the main server 128 is transmitted from the controllers 116, 126 over a wireless mesh network (other network types could also be used (e.g., wired, or wireless non-mesh)). Accordingly, as shown in the illustrated example of FIG. 1, each of the controllers 116, 126 is equipped with an IO communication board 134 that includes a wireless transceiver (e.g., a radio) to transmit the IO data according to any suitable communications protocol. In some examples, the IO boards of the controllers 116, 126 transmit IO data directly (e.g., without a mesh network) to a receiver associated with the main server 128. In other examples, the IO data from one controller may be transmitted to the main server 128 indirectly via the IO communication board 134 in a different controller and/or via any other device or component capable of communicating on the mesh network (e.g., one or more gateways, relays, repeaters, etc.). In some examples, the IO boards of the controllers 116, 126 are implemented with a reusable firmware module that converts and normalizes data collected by the different controllers into a common format corresponding to the particular communication protocol. The reusable nature of the firmware enables the firmware to be embedded into existing products so that they may be modified for integration in the monitoring system of the main server 128. Enabling each of the controllers 116, 126 to transmit data in a common format according to a single communications protocol enables the main server 128 to directly integrate and associate data collected from different types of controllers regardless of the original source of the data and/or nature and/or type of sensors used to generate such data.

In some examples, transmissions from the controllers 116, 126 reporting IO data include device identification information that includes an identifier, name and/or type for the device or controller sending the message as well as an address for the device on the network. The device identification information enables the main server 128 to determine the source of the message (e.g., the controller that sent the message). In some examples, the IO data includes values of particular IO parameters monitored and/or generated by the controller. In some examples, the values of the IO parameters correspond to measured outputs of sensors monitored by the corresponding controller (e.g., an output of a door sensor indicating whether the door 104 is open or closed). In other examples, the values of the IO parameters are not directly measured or sensed but are derived based on one or more measured values (e.g., deriving the transitional state of the door 104 (e.g., opening or closing) based on the last state of the door sensor and a signal from an actuator sensor indicating the door actuator is moving the door).

As mentioned above, the main server 128 serves as a central hub to aggregate and/or integrate data associated with the disparate systems (e.g., different docks 102 and/or industrial doors 124) operating throughout the material handling facility 100. In some examples, the main server 128 includes, corresponds to, and/or is associated with a web server 136 that hosts one or more web pages accessible by a user via a client device 138. Client devices 138 may be any suitable computing device with a browser to access the web pages hosted by the web server 136. Thus, the client devices 138 may correspond to one or more operator stations located at the material handling facility 100 (e.g., in the logistics office of the facility). In some examples, the client devices may be portable devices (e.g., tablets, smartphones, etc.) carried by personnel throughout the material handling facility 100 and/or remotely away from the facility. Further, some client devices 138 may be portable devices used by truck drivers hauling trailers to or from the material handling facility 100 and/or yard jockeys who reposition trailers at the docks 102 and/or within the yard of the material handling facility 100.

The different web pages may include different graphical user interfaces designed to present different types of information in a format that is easy to understand and facilitates a user in recognizing the relationship of data collected from different sources within the material handling facility 100. In some examples, the main server 128 automatically causes the one or more of the web pages to be updated through web-based communications 140 any time new data is collected that is relevant to the particular web pages. Further, in some examples, the web pages are designed to receive user input that is provided back to the main server 128. In some examples, web page updates are implemented based on pull requests from the client devices requesting updated information. Additionally or alternatively, in some examples, updates may be pushed to web pages actively opened by specific client devices for dynamic updating through the use of push requests. In some examples, user input received at one web page may be pushed to other web pages that are displaying information relating to the user input (e.g., other web pages being accessed by other client devices 138). Although graphical user interfaces are disclosed in connection with web pages herein, the graphical user interfaces may be presented using something other than web pages (e.g., via an app, applet, application, etc.). In some examples, the graphical user interfaces are provided via a display associated with the example notification system 114 that is local to a particular dock 102 as discussed above in connection with FIG. 1.

In some examples, the main server 128 analyzes information provided from the separate systems within the material handling facility 100 to identify circumstances, conditions, and/or events (collectively referred to herein as events) that may need a response or other resolution. In some examples, the identification of such events is based on configurable rules that depend on feedback (e.g., particular IO data) from multiple different ones of the controllers 116, 126. In some examples, the main server 128 triggers particular responses based on the detection of particular events (e.g., when the conditions of associated event rules are satisfied). In some examples, the response may include providing information and/or instructions back to one or more of the controllers 116, 126 to cause such controllers to initiate some action in the equipment associated with the corresponding controller (e.g., open or close a door; change the operational state of a fan, a blower, or conveyor; switch the status of an indicator light; etc.). In some examples, the main server 128 may respond to particular events by generating alerts, warnings, notifications, log entries, and/or reports (collectively referred to herein as notifications) that are provided to one or more client devices 138. In some examples, such notifications may be provided via the web communications 140 as the web pages are updated. Additionally or alternatively, the main server 128 may provide notifications to the client devices 138 independent of the web server 136 using other forms of network communications 142 such as, for example, email messages, SMS (Short Message Service) messages, push notifications, etc. Additionally or alternatively, the main server 128 may transmit notifications for rendering via a local display screen (e.g., the display screen 118) associated with one of the controllers 116, 126 throughout the facility 100. In this manner, such notifications provide information to personnel located in proximity with the same controllers that reported information to the main server 128 that was used to generate the notifications.

Providing automatic notifications to individuals, as disclosed herein, enables those individuals to become aware of certain events that would otherwise remain unknown. This is a significant improvement to the efficient use and operation of the control systems described above because the events may correspond to activities disruptive to efficient loading, unloading, and/or storage of goods at the facility 100, activities that pose safety risks to personnel within and/or around the facility 100, activities that pose a risk of damage to the equipment used within the facility 100, etc. Through the monitoring of the various systems and operations within the material handling facility 100 and the automatic generation and transmission of notifications, examples disclosed herein enable relevant individuals to implement appropriate action responding to the various notifications (e.g., reversing actions previously taken that triggered the notification, providing additional training to reduce or eliminate the trigger event, scheduling and/or implementing preventative and/or maintenance activities, restructuring process flows and/or equipment usage procedures, etc.).

In some examples, the nature or content of a particular notification depends on the nature of the particular event that triggered the notification. More particularly, in some examples, in addition to identifying the occurrence of safety events, the main server 128 tracks or logs such events over time to categorize different types of safety events by frequency (e.g., quantity), location, and/or time of day. Based on these factors, the main server 128 can select a particular corrective action from a set of possible corrective actions for the event type that can be specified in a notification to a user via the graphical user interface and/or another messaging system. The frequency or number of different occurrences of a particular type of event can indicate whether the event is something that happens regularly or is a one-off type of situation, which can affect the particular corrective action selected by the main server 128 to recommend to a user. The location of a particular type of event can also affect what particular corrective action is selected based on whether the event occurs widely across multiple docks 102 and/or doors 124 (suggesting it may be an issue of the way personnel are using the equipment) or whether the event occurs only at a specific dock 102 and/or door 124 (suggesting it may be an issue with the equipment at the particular dock 102 and/or door 124 involved in the event). The time of day affects the selection of the particular corrective action in that safety events that always occur during a particular block of time during the day are an indication the problem arises due to activity during the particular block of time. For instance, if the block of time corresponds to a particular work shift at the material handling facility 100, a majority (or all) safety events occurring during that work shift indicate a likelihood that the way the personnel working during the particular shift are the cause of the safety event. By contrast, if a particular type of safety event occurs at different times throughout the day, particular personnel cannot be isolated as being the source of the problem. Instead, it may be that all personnel need new training and/or the operation and/or configuration of the equipment needs to be updated.

In view of the foregoing factors, in some examples, the main server 128 divides or categorizes safety events of a particular type into one of four scenarios including: (1) occurring at one location (e.g., one dock 102 or one door 124) during one block of time (e.g., one shift) during a day, (2) occurring at one location during multiple blocks of time during the day, (3) occurring at multiple locations during one block of time during the day, and (4) occurring at multiple locations during multiple blocks of time during the day. In some examples, the set of possible corrective actions from which the main server 128 selects a particular corrective action includes a different corrective action for each of the four scenarios listed above. In some examples, the set of possible corrective actions for a given type of safety event may differ from the set of possible corrective actions for a different type of safety event. In other examples, the same set of possible corrective actions are used for multiple different types of safety events.

Different example corrective actions to be recommended for each of the four scenarios are summarized for different example safety events in Tables 1-8. In particular, Table 1 outlines example corrective actions for a safety event at a dock 102 triggered by the presence/motion detector 204 detecting movement in a trailer when the vehicle restraint 110 is not engaged to secure the trailer. This is a safety event because it presents the possibility of the trailer being pulled away while some is working inside the trailer.

TABLE 1
Corrective Actions for Unsafe Loading/Unloading from Trailer

| | | Location | |
|---|---|---|---|
| | | One dock | Multiple docks |
| Time | One | Observe the dock | Observe the relevant docks. |
| of | shift | during the shift and | Consider adding interlock (e.g., |
| Day | | monitor behavior of | a leveler interlock with the go |
| | | personnel. | (green) light on the light |
| | | | indicator 206. |
| | Multiple | Observe the docks | Consider general training. |
| | shifts | to determine why | Consider adding interlock with |
| | | the event is | the go (green) light on the light |
| | | occurring. | indicator 206. |

Table 2 outlines example corrective actions for a safety event at a dock 102 triggered by the vehicle restraint 110 being in override (in which case it would not be engaged with a trailer at the dock) and the presence detector 112 indicating no trailer is present at the dock 102. This is a safety event because it indicates the possibility of the dangerous scenario in which a trailer was pulled from the dock 102 while the light indicator 206 was on a stop (red) light in violation of the standard sequence of operations for truck departure. It is possible for the above event to be triggered without a trailer ever being at the dock, such as when the dock door 104 is opened by personnel to cool the building or some other reason other than loading or unloading a trailer. Accordingly, in some examples, the main server 128 confirms the presence of a trailer by cross-checking the timestamps on log entries for the arrival and departure of trailers at the dock 102. In addition to the corrective actions set forth in Table 2, the main server 128 may also identify and/or provide one or more videos that demonstrate or provide training on the proper use of the vehicle restraint override and/or on stop (red) light departure conditions.

TABLE 2
Corrective Actions for Unsafe Trailer Departures

| | | Location | |
|---|---|---|---|
| | | One dock | Multiple docks |
| Time | One | Observe the dock during | Observe the relevant |
| of | shift | the shift and monitor | docks. |
| Day | | behavior of personnel. | |
| | Multiple | Observe the docks to | Consider general training |
| | shifts | determine why the event | (for drivers and/or |
| | | is occurring. | facility personnel). |

Table 3 outlines example corrective actions for a safety event at a dock 102 triggered by the door 104 at the dock being open while no trailer is present and the doorway barrier 106 not being engaged. Table 4 outlines example corrective actions for a similar safety event at a dock 102 that does not include the doorway barrier 106. The absence of a barrier 106 (either not available at the dock or available but not engaged) while the door is open and no trailer is present creates a potential falloff hazard.

TABLE 3
Corrective Actions for Potential Falloff Hazard
when Doorway Barrier is Available but Not Engaged

| | | Location | |
|---|---|---|---|
| | | One dock | Multiple docks |
| Time | One | Observe the dock during | Observe the relevant docks. |
| of | shift | the shift and monitor | Consider adding interlock |
| Day | | behavior of personnel. | between door and barrier. |
| | Multiple | Observe the docks to | Consider general training. |
| | shifts | determine why the event | Consider adding interlock |
| | | is occurring. | between door and barrier. |

TABLE 4
Corrective Actions for Potential Falloff Hazard
when Doorway Barrier is Not Available

| | | Location | |
|---|---|---|---|
| | | One dock | Multiple docks |
| Time | One | Observe the dock during | Observe the relevant docks. |
| of | shift | the shift and monitor | |
| Day | | behavior of personnel. | |
| | Multiple | Observe the docks to | Consider general training. |
| | shifts | determine why the event | |
| | | is occurring. | |

Table 5 outlines example corrective actions for a safety event at a dock 102 triggered by the vehicle restraint 110 being in override. As discussed above, in some examples, the vehicle restraint is placed in override because the restraint is not able to latch onto or engage a particular trailer (e.g., the trailer includes a liftgate, the trailer does not include a rear impact guard, etc.). Accordingly, as detailed in Table 5, the corrective actions include investigating the conditions of the trailer to confirm whether the event was a time when it was necessary to override the restraint or a failure to follow the proper sequence of operations.

TABLE 5
Corrective Actions for Vehicle Restraint in Override

| | | Location | |
|---|---|---|---|
| | | One dock | Multiple docks |
| Time | One | Observe the dock during | Observe the relevant |
| of | shift | the shift and monitor | docks. Investigate carrier |
| Day | | behavior of personnel. | trailer conditions |
| | | Investigate carrier | (Liftgates/Missing Rear |
| | | trailer conditions | Impact Guard) |
| | | (Liftgates/Missing Rear | |
| | | Impact Guard) | |
| | Multiple | Observe the docks to | Consider general training. |
| | shifts | determine why the event | Investigate carrier |
| | | is occurring. Investigate | trailer conditions |
| | | carrier trailer conditions | (Liftgates/Missing Rear |
| | | (Liftgates/Missing Rear | Impact Guard) |
| | | Impact Guard) | |

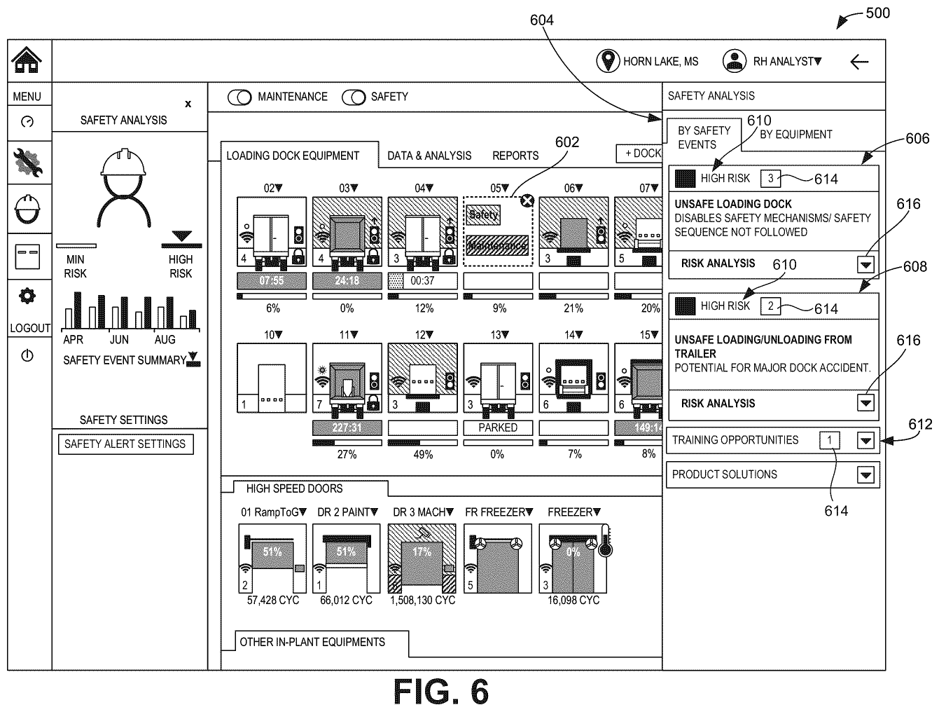

Table 6 outlines example corrective actions for a safety event at an interior industrial door 124 triggered by a breakaway sensor detecting that the door panel was forced out of the tracks intended to guide movement of the panel. Typically, such breakaway events are caused by a large object (e.g., a forklift) hitting the door panel as it is moving between open and closed positions. However, door breakaways can also occur due to a pressure blowout. Accordingly, in some examples, the main server 128 relies on additional IO data to distinguish between these scenarios and, based on that determination, recommends different correction action. Additionally or alternatively, the corrective action recommended by the main server 128 can include a direction to have the nature of the breakaway event determined. A breakaway event caused by an impact with a forklift when the door is opening can indicate that the activation time to move from a closed position to the open position is insufficient. By contrast, a breakaway event caused by an impact with a forklift when the door is closing can indicate that the sensing around the doorway to ensure the doorway is clear before closing is insufficient. Additionally or alternatively, an impact when the door is closing may also indicate the time the door remains open before closing (based on a close timer) is too short to allow passage through the doorway. Accordingly, in some examples, the main server 128 uses additional IO data indicating the direction of door travel to infer the particular scenario and select a particular corrective action tailored to the scenario. Options for different example corrective actions are shown in FIG. 6 for impacts when a door is opening verses impacts when a door is closing. Additionally or alternatively, the corrective action recommended by the main server 128 can include a direction to have the direction of door travel determined.

TABLE 6
Corrective Actions for Door Panel Breakaway

| | | Location | |
|---|---|---|---|
| | | One door | Multiple doors |
| Time | One | Observe the door | Observe the relevant doors. |
| of | shift | during the shift | Evaluate duration of door open |
| Day | | and monitor | time for impacts on closing. |
| | | behavior of | Evaluate activation sensor |
| | | personnel. | settings and/or door speed for |
| | | | impacts on opening. |
| | Multiple | Observe the door | Consider general training (for |
| | shifts | to determine | operators/personnel). |
| | | why the event is | Evaluate duration of door open |
| | | occurring. | time for impacts on closing. |
| | | | Evaluate activation sensor |
| | | | settings and/or door speed for |
| | | | impacts on closing. |

Table 7 outlines example corrective actions for a safety event at an interior industrial door 124 triggered by a door failing to refeed into tracks after a breakaway event.

TABLE 7
Corrective Actions for Improper Door Refeed

| | | Location | |
|---|---|---|---|
| | | One door | Multiple doors |
| Time | One | Check door to confirm | Check relevant doors to |
| of | shift | operational. Observe | confirm they are operational. |
| Day | | the door during the | Observe the relevant doors. |
| | | shift and monitor | Evaluate door open time. |
| | | behavior of personnel. | |
| | Multiple | Check door to confirm | Check relevant doors to |
| | shifts | operational. Observe | confirm they are operational. |
| | | the door to determine | Consider general training |
| | | why the event is | (for operators/personnel). |
| | | occurring. | Evaluate sensor settings and |
| | | | door open time. |

Table 8 outlines example corrective actions for a safety event at an interior industrial door 124 triggered by a door controller 126 reporting a door reversal (e.g., door closing and then switching to move to the open position based on detection of something or someone passing through the doorway under the closing door). In addition to the example corrective actions set forth in Tables 1-8, the main server 128 may also identify and/or provide one or more videos that demonstrate or provide training on how to avoid the relevant safety event(s) that triggered the need for the corrective action. For example, the main server 128 may identify and/or provide a video demonstrating the proper sequence of operations at a dock.

TABLE 8
Corrective Actions for Door Reversal

| | | Location | |
|---|---|---|---|
| | | One door | Multiple doors |
| Time | One | Observe the door during | Observe the relevant doors. |
| of | shift | the shift and monitor | Evaluate door open time. |
| Day | | behavior of personnel. | |
| | Multiple | Observe the door to | Consider general training |
| | shifts | determine why the | (for operators/personnel). |
| | | event is occurring. | Evaluate sensor settings |
| | | | and door open time. |

As set forth above, each of the Tables 1-8 outline four possible scenarios based on whether a particular safety event is associated with a single block of time (e.g., a single shift) or multiple blocks of time (e.g., multiple shifts) and based on whether the safety event is associated with a single location (e.g., a single dock or door) or multiple locations (e.g., multiple docks or doors). However, in other examples, different categorizations and/or groupings of these factors and/or other factors can be included to define different scenarios with different corresponding corrective actions. In some examples, artificial intelligence can be used to analyze and categorize historical data to identify patterns and/or determine particular scenarios for which particular corrective actions may be suitable.

Generally speaking, artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

In general, implementing a ML/AI system involves two phases, a learning/training phase and an inference phase. In the learning/training phase, a training algorithm is used to train a model (e.g., a neural network) to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

FIG. 5 is an example graphical user interface presented by an example equipment monitoring web page 500. As shown in the illustrated example, the equipment monitoring web page 500 includes graphics, icons, symbols and/or associated information representative of the conditions and or states of a series of docks 102 and/or other doors 124 of the material handling facility 100 as determined based on the data collected by the main server 128 from the dock controllers 116, 126 and/or other devices in communication with the main server 128. In this example, different docks 102 of the material handling facility 100 are graphically represented by a series of individual dock graphics, images, or icons 502. In this example, different ones of the dock graphics 502 differ in appearance based on differences in the corresponding docks 102 represented by the different dock graphics 502. Specifically, the dock graphics 502 differ based on differences in the equipment associated with the docks 102 and/or the nature of the dock doors 104 implemented at respective ones of the docks 102. For instance, the dock graphic 502 identified by dock number 10 is represented by a grade-level door 504 while all the other dock graphics 502 include an elevated dock door 506 to indicate different types of doors 104 implemented at corresponding ones of the docks 102. In some examples, the dock graphics 502 associated with elevated dock doors 506 also include graphical representations of different types of equipment implemented at the corresponding docks 102. For instance, a vehicle restraint indicator, icon, or symbol 508 represent the presence of the vehicle restraint 110 of FIGS. 1 and 2. Further, a light indicator, icon, or symbol 510 represents the presence of the light indicator 206 of FIG. 2. Further, in this example, the dock graphics 502 identified by dock numbers 05, 14, and 15 include a seal indicator, icon, or symbol 512 positioned around the associated dock doors 506 to represent the presence of a seal at the specified docks 102, while all other dock graphics 502 do not include a seal indicator, icon, or symbol 512. Additionally, in this example, the dock graphics 502 identified by dock numbers 05, 07, and 14 are represented with a barrier indicator, icon, or symbol 513 to indicate the corresponding dock 102 includes a doorway barrier 106 shown in FIGS. 1-4.

In the illustrated example, the dock graphics 502 include an equipment number indicator 514 that specifies the number of connected devices or pieces of equipment from which the main server 128 is receiving IO data (e.g., via an associated dock controller 116). Further, in some examples, the dock graphics 502 include a connection status indicator 518 to indicate whether the main server 128 is able to communicate with the dock controller 116 for each corresponding dock 102. In some examples, if a connection is lost, the connection status indicator 518 may change appearance (e.g., begin flashing, change color (become grayed out), or disappear entirely).

In some examples, the dock graphics 502 are adjusted and/or updated in substantially real-time to convey status information associated with the corresponding docks 102 represented by the dock graphics 502. For example, in some examples, the barrier icon 513 changes appearance to distinguish between when the barrier 106 is in active use and blocking the doorway (as shown in FIG. 2) and when the barrier 106 is stowed away (as shown in FIG. 3). In some examples, the barrier indicator 513 only appears in response to feedback indicating the barrier is blocking the doorway. Similarly, as shown in connection with the dock graphic 502 identified by dock number 06, the dock door 506 may not be shown to indicate the door is open. In some such examples, the open state of the door is further indicated by an arrow 516 pointing upwards. In some examples, when a trailer sensor 202 detects and/or generates a signal indicative of the presence of a trailer at a corresponding dock, a trailer icon 520 is shown in front of the corresponding dock door 506. In some such examples, the light indicator 510 switches from a go (green) light (as in the dock graphic 502 identified by dock number 02) to a stop (red) light (as in the dock graphic 502 identified by dock number 02) in response to the vehicle restraint 110 being activated. Further, in some examples, a lock indicator, icon, or symbol 507 is also shown to indicate when the restraint 110 is activated to restrain the trailer. In some examples, the lock indicator 507 can change appearance (e.g., change color, become grayed out, disappear entirely, begin flashing, include a prohibition symbol overlaid thereon, shown to be unlocked, etc.) to indicate when the restraint has been placed into an override mode.

As shown in the illustrated example, the trailer indicator, icon, or symbol 520 can be represented either with the trailer doors closed (as in the dock graphic 502 identified by dock number 02) or with the trailer doors opened (as in the dock graphic 502 identified by dock number 03). In some examples, the trailer doors being open is intended to indicate when the dock leveler 108 has been activated and in position to enable personnel to enter the trailer. Further, in some examples, a forklift indicator, icon, or symbol 522 is shown within the trailer indicator 520 (as in the dock graphic 502 identified by dock number 11) in response to a presence/motion detector 112 detecting movement within the trailer. In some examples, a presence/motion detector indicator, icon, or symbol 524 appears to indicate whether movement within the trailer is being monitored regardless of whether motion is detected (and the forklift icon 522 is shown). That is, in some examples, the presence/motion detector indicator 524 is provided in the dock graphics 502 that include a presence/motion detector 112 to implement the monitoring of motion in the trailer. In some examples, when motion is detected in a trailer, the presence/motion detector indicator 524 changes appearance (as indicated by the difference in the indicator 524 as shown at dock number 02 relative to dock number 11). The change in appearance of the presence/motion detector indicator 524 can be any suitable change (e.g., begin flashing, change color, become highlighted, become brighter, changes size, etc.).

In some examples, a timing indicator 526 is provided in connection with each dock graphic 502 that is currently associated with a trailer that is being actively loaded and/or unloaded. In some examples, the timing indicator 526 provides the same timing information as the timing indicator 306 discussed above in connection with FIG. 3. In some examples, when a trailer is parked at a dock but not actively being loaded or unloaded, a parked indicator 528 is provided as shown in connection with dock number 13 of FIG. 5. In some examples, a utilization indicator 530 is also provided in connection with each dock graphic 502 to indicate a percentage of the utilization of the corresponding dock 102 in the material handling facility 100.

In the illustrated example of FIG. 5, the equipment monitoring web page 500 includes a series of industrial door graphics, images, or icons 532 to graphically represent corresponding industrial doors 124 within the material handling facility 100. In this example, different ones of the door graphics 532 differ in appearance based on differences in the corresponding doors 124 represented by the different door graphics 532. For instance, the door graphics 532 can differ in appearance to represent different types of doors (e.g., vertical translating door, roll-up door, horizontal translating door, etc.) and/or different mechanisms (e.g., motorized mandrel or roller, a motorized gear that interfaces with openings in and/or protrusions on lateral edges of the door panel, etc.) by which the corresponding doors 124 are opened and closed. Further, in some examples, a thermometer indicator, icon, or symbol 534 may be included to indicate that the corresponding door is a freezer door. In some examples, the thermometer indicator 534 may dynamically change to reflect a measured temperature of an associated freezer room. In some examples, the door graphics 532 include one or more fan indicators, icons, or symbols 536 to indicate the presence of one or more fans that produce air currents near the doors (e.g., to reduce condensation on the doors). In some examples, the number of fan indicators 536 associated with a given door graphic 532 is representative of the number of fans implemented in connection with the corresponding door 124. In some examples, the door graphics 532 include a motion sensor indicator, icon, or symbol 538 to indicate the presence of a motion sensor that can sense movement (e.g., approaching traffic) in the vicinity of the door. In some examples, both sides of the door can be monitored by a separate motion sensor. In some such examples, more than one motion sensor indicator 538 can be provided. However, in other examples, a single motion sensor indicator 538 is provided to represent both sensors. In some examples, the motion sensor indicator 524 changes appearance (e.g., changes color, begins flashing, brightens, changes size, etc.) in response to the traffic sensor detecting the presence of traffic

In some examples, whether a particular door 124 within the material handling facility 100 is opened or closed (or at some position therebetween) can be represented based on the appearance of the corresponding door graphic 532 in the equipment monitoring web page 500. In other examples, the position of the door panel in the door graphics 532 can represent the amount of time a particular door is open over a given period of time. The given period of time can be any suitable period of time (e.g., one day, one week, two weeks, thirty days, one month, etc.). For instance, in this example, the door graphic 532 labelled as “01 RampToG” is shown with the door panel approximately half way open to indicate that during the most recent period of time (e.g., the last thirty days), the door was open approximately half of the time. In some examples, a specific percentage value 540 is provided (e.g., 51% for the “01 RampToG” door graphic 532) to more precisely indicate the proportion of time that the door was open during the most recent period of time.

In some examples, a cycles indicator 542 is provided along with each door graphic 532 to indicate the number of cycles the door has undergone. In some examples, the cycles indicator 542 represents the number of cycles over a most recent period of time (e.g., one day, one week, two weeks, thirty days, one month, etc.). In other examples, the cycles indicator 542 represents the number of cycles since the last time maintenance was performed on the door. In other examples, the cycles indicator 542 represents the number of cycles over the entire life of the door.

In some examples, ones of the dock graphics 502 and/or ones of the door graphics 532 may change in appearance when the corresponding dock 102 and/or industrial door 124 is associated with an event (e.g., a safety event, a maintenance event) triggered by the conditions and/or state of the corresponding docks 102 and/or doors 124 satisfy the conditions of an event rule defined for the material handling facility 100. In some examples, the change in appearance corresponds to a change in color of some or all of the graphics 502, 532. In the illustrated example, the wall surrounding the doorway at the docks 102 and/or the doors 124 change color to indicate an event has been detected in association with the corresponding dock or door (e.g., either the door associated with a dock 102 or the door corresponding to one of the industrial doors 124). In some examples, the change in color is limited to the occurrence of events detected within a most recent threshold period of time (e.g., the last 30 days). In some examples, different colors are used to represent different categories or groupings of events. For instance, in some example, safety events are indicated by the color yellow while maintenance events are indicated by the color red. In some examples, both safety events and maintenance events are indicated by a first portion of the graphics (e.g., the upper portion of the wall surrounding and above the doorway) being changed to yellow and a second portion of the graphics (e.g., the lower portion of the wall to the lateral sides and/or underneath the doorway) being changed to red. In other examples, different colors than yellow and red can be used. Additionally or alternatively, in other examples, different changes in appearance other than changes in color can be used to indicate the occurrence of safety events, maintenance events, and/or other types of events.

In some examples, clicking on or otherwise selecting a dock or door associated with a detected event can give a user the option to review additional details about the events. For example, FIG. 6 illustrates the equipment monitoring web page 500 after selecting the dock graphic 502 associated with dock number 05. As shown in the illustrated example, selecting the dock graphic 502 converts the graphic into an events selection graphic 602 that enables a user to select information associated with safety events or maintenance events. In this example, the user has selected the safety events to reveal a safety analysis pop-up 604 that provides further detail regarding safety events associated with the corresponding dock 102. In some examples, the safety analysis pop-up 604 can alternatively be rendered as a sidebar so as not to conceal any of the dock graphics 502 and/or door graphics 532 shown on the equipment monitoring web page 500. In some examples, the safety analysis pop-up 604 can be rendered as a completely separate window and/or web page.

In the illustrated example of FIG. 6, the safety analysis pop-up 604 identifies different safety event cards 606, 608 associated with different types of safety events. The safety event cards are an example type of notification the main server 128 provides to a user containing safety analysis information. The safety event cards 606, 608 indicate a level of risk indicator 610 that identifies a level of risk associated with the corresponding type of safety event. In some examples, safety events are categorized into two levels of risk including high risk and low risk. As used in this context, a high risk safety event is an event that gives rise to an actual risk of injury or harm to a person and/or equipment. By contrast, a low risk safety event is an event that has no real threat of injury or harm to a person or equipment because the injury or harm is prevented from being realized due to the configuration of the equipment (e.g., based on an interlock). However, such events are still considered safety events (though low risk) because they arise based on behavior that has the potential of giving rise to harm or injury if the equipment was not configured to prevent such and/or the preventative measures implemented by the equipment fail to operate as intended. In other words, low risk safety events are events based on individuals attempting to perform an unsafe action that is prevented based on the configuration of the equipment.

As a specific example, opening a dock door 104 when no trailer is present and a doorway barrier 106 is not engaged to block passage through the open doorway presents a falloff hazard. Because a falloff can be realized in this situation, this would constitute a high risk safety event. However, if an interlock were established that prevented someone from opening the door unless a trailer was present or the doorway barrier 106 was in place, this danger would never actually be realized and, therefore, can be categorized as a low risk safety event. Even though there is no real risk because the door is prevented from being opened, the mere fact that a person attempted to open the door (but was prevented from doing so due to the interlock) still presents a risk because it demonstrates the person does not understand the potential risk involved by their attempt to open the door as outlined above. Thus, while low risk events do not present any significant risk of actual harm or injury, they nevertheless correspond to opportunities for training personnel so that they do not attempt unsafe behavior (even if the danger of such is prevented by the configuration of equipment). Accordingly, low risk safety events are also referred to herein as training opportunities and may be represented within the training opportunities card 612 of the safety analysis pop-up 604.

Other types of low risk safety events or training opportunities (that may not give rise to actual risk of harm or injury due to preventative measures configured into the equipment) include a user attempting to open a dock door 104 when the vehicle restraint 110 is not engaged (and not in override), a user attempting to deploy the dock leveler 108 when the door 104 is not fully open, a user attempting to deploy the leveler 108 when the vehicle restraint 110 is not engaged, a user attempting to unlock or disengage the vehicle restraint 110 while there is activity detected in the trailer, a user attempting to unlock or disengage the vehicle restraint 110 while the leveler 108 is deployed, a user attempting to store the leveler 108 while there is activity detected in the trailer, a user attempting to close the door 104 when there is activity detected in the trailer, a user attempting to close the door 104 when the leveler 108 is deployed, a user attempting to unlock or disengage the vehicle restraint 110 before the door 104 is closed, a user attempting to unlock or disengage the vehicle restraint 110 before the doorway barrier 106 is engaged, and a user attempting to lower a vertical leveler 108 when motion is detected in the dock leveler pit 402.

As shown in FIG. 6, both the safety event cards 606, 608 and the training opportunities card 612 include a count indicator 614 that indicates a total number of docks and/or doors affected by the particular type of event associated with each card 606, 608, 612. In some examples, the count is limited to a most recent period of time (e.g., the last 30 days or any other suitable timeframe). In some examples, the count indicator 614 corresponds to all docks and/or doors across the material handling facility 100 to indicate a prevalence of the particular safety event. Thus, the fact that the safety analysis pop-up 604 was accessed by selected dock number 05 is irrelevant to the numbers included in the count indicators 614. However, in some examples, the particular types of events represented in the safety analysis pop-up 604 correspond to the types of safety events that have occurred in connection with the selected dock number 05. Thus, in this example, the dock 102 represented by dock number 05 in FIG. 6 has been associated with an unsafe loading dock safety event (indicated by the first safety event card 606) and an unsafe loading/unloading form trailer safety event (indicated by the second safety event card 608). If a different dock graphic 502 in the equipment monitoring web page 500 was selected, the particular safety event cards that appear in the safety analysis pop-up 604 may differ depending on the particular safety events that have been detected in connection with the dock represented by the selected dock graphic 502.

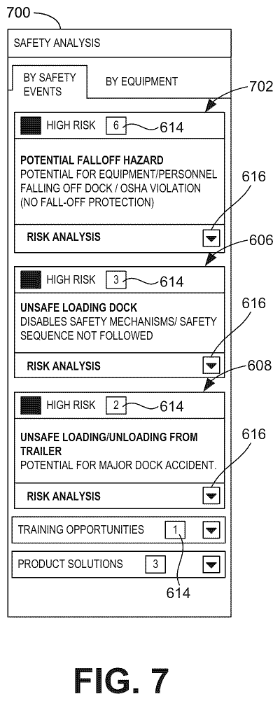

For instance, FIG. 7 illustrates a different example safety analysis pop-up 700 associated with a different dock in the material handling facility 100. As shown in FIG. 7, the safety analysis pop-up 700 includes the same two safety event cards 606, 608 as shown in the safety analysis pop-up 604 of FIG. 6. As such, both the dock selected in connection with the safety analysis pop-up 700 of FIG. 7 and dock number 05 selected in connection with the safety analysis pop-up 604 of FIG. 6 are associated with the same types of safety events. Notably, the count indicators 614 for these safety event cards 606, 608 is the same in both FIG. 6 and FIG. 7 because, as described above, the number represents all docks associated with the particular safety event. However, the safety analysis pop-up 700 of FIG. 7 includes an additional safety event card 702 associated with a potential falloff hazard safety event that does not appear in FIG. 6 because this particular safety event was not detected in connection with dock number 05 during the relevant period of time. In other examples, the safety analysis pop-ups 604, 700 may be identical in content and represent all safety events across the material handling facility 100 without providing an indication of which events correspond to the particular dock selected when accessing the safety analysis pop-up.

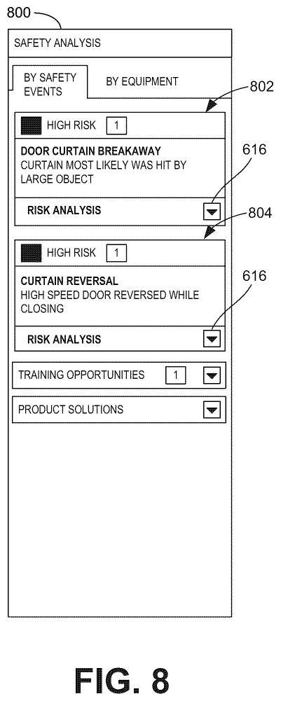

FIG. 8 illustrates another example safety analysis pop-up 800 that includes safety event cards 802, 804 corresponding to particular types of safety events associated with industrial doors 124. Each of the safety event cards 606, 608, 702, 802, 804 includes a risk analysis dropdown 616 that can be expanded to access more detailed information corresponding to the type of safety event represented by each card. In some examples, the risk analysis dropdown 616 includes information about the frequency (e.g., quantity), location, and time of day of different instances or occurrences the particular safety event throughout the material handling facility 100. As described above, these factors are used to provide recommendations for corrective actions discussed above in connection with Tables 1-8. In some examples, the particular corrective action selected by the main server 128 is based on the frequency, location, and/or time of day of the occurrences of the safety event.

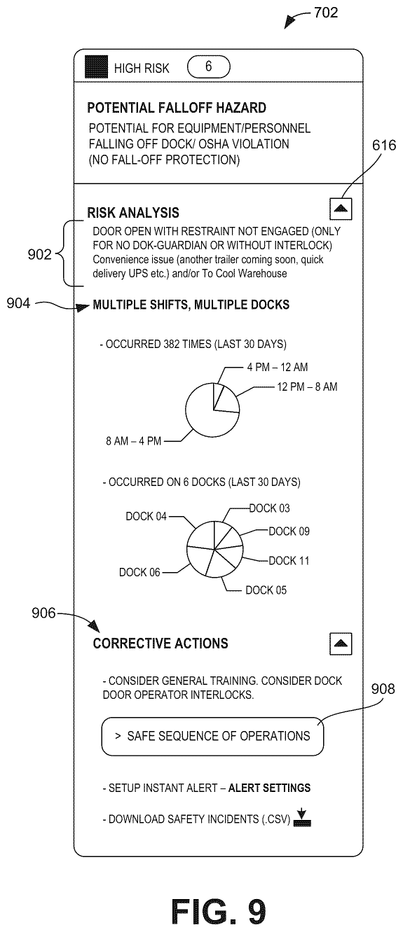

More particularly, FIG. 9 illustrates the example safety event card 702 of FIG. 7 with the risk analysis dropdown 616 expanded to show the details contained therein. In this example, the risk analysis dropdown 616 includes an event summary 902 that explains the scenario(s) giving rise to the safety event. The example risk analysis dropdown 616 also includes a time and location summary 904 that identifies the scope or breadth of occurrences of the safety event across different blocks of time (e.g., different shifts) during the day and across different locations (e.g., different docks and/or doors). In some examples, the time and location summary 904 corresponds to one of four scenarios including: (1) Single Shift, Single Dock (or Door), (2) Single Shift, Multiple Docks (or Doors), (3) Multiple Shifts, Single Dock (or Door), and (4) Multiple Shifts, Multiple Docks (or Doors). Thus, the time and location summary 904 identifies one of the four options in each of the Tables 1-8 discussed above. In some examples, a safety event associated with the first scenario (Single Shift, Single Dock) is referred to as an isolated safety event because it is isolated to a particular dock (or door) during a particular shift.

In some examples, as shown in FIG. 9, the risk analysis dropdown 616 provides further information including a total number of occurrences or instances of the safety event as well as a representation of a breakdown of the proportion of the total number of instances of the safety event that occurred in each different block of time. In this example, the breakdown or distribution of the different instances of the safety events across different blocks of time are represented by a pie chart. However, the breakdown or distribution can be represented in any other suitable way. As shown in the illustrated example, the vast majority (approximately 75%) of the falloff hazard safety events occurred during the morning shift between 8 am and 4 pm. Thus, while the time and location summary 904 indicates multiple shifts, the additional information clarifies that a single particular shift is the primary source of the occurrences of the safety event. In some examples, if the proportion of instances of a safety event during a particular shift satisfy (e.g., exceed) a threshold less than 100% (e.g., 85%, 90%, 95%, 98% etc.), the time and location summary 904 may indicate that only one shift is associated with the safety event to select an appropriate corrective action that is focused on the particular shift that is the primary source of all safety events (even though there may be a small proportion of instances of the safety event that occurred during different shifts). In other examples, the time and location summary 904 may indicate the safety event is associated with one single shift only when all events are actually associated with the single shift (e.g., only when a threshold of 100% is satisfied). While the illustrated example shows that the blocks of time correspond to shifts during the day, any suitable blocks of time can be used.

Further, in some examples, the risk analysis dropdown 616 provides a breakdown of the proportion of the total number of instances of the safety event that occurred at each different dock or door at which the safety event occurred at least once. In this example, the breakdown or distribution of the different instances of the safety events across the docks are represented by a pie chart. However, the breakdown or distribution can be represented in any other suitable way. As shown in the illustrated example, while the vast majority of the falloff hazard safety events occurred during the morning shift between 8 am and 4 pm, the different instances of the safety event are distributed relatively evenly across all six identified docks. In some examples, if the proportion of instances of a safety event at a particular dock satisfy (e.g., exceed) a threshold less than 100% (e.g., 85%, 90%, 95%, 98% etc.), the time and location summary 904 may indicate that only dock is associated with the safety event to select an appropriate corrective action that is focused on the particular dock that is the primary source of all safety events (even though there may be a small proportion of instances of the safety event that occurred at different docks). In other examples, the time and location summary 904 may indicate the safety event is associated with one single dock only when all events are actually associated with the single dock (e.g., only when a threshold of 100% is satisfied).

In the illustrated example of FIG. 9, the risk analysis dropdown 616 also provides recommended corrective actions 906. As described above, the recommended corrective actions 906 are selected from a set of possible corrective actions based on the frequency, location, and time of day of the safety events. More particularly, in some examples, the particular corrective action(s) are based on the determination of the particular one of the four possible scenarios provided in the time and location summary 904. Different example corrective actions for each of the scenarios for different types of events are detailed above in connection with Tables 1-8. In some examples, the corrective actions 906 includes a training button 908 that provides access to a training video explaining the proper (safe) sequence of operations that would avoid the safety event at issue in the safety event card 702 of FIG. 9. In some examples, the training video is provided directly inside of the safety event card 702. In other examples, the safety event card 702 provides a link to enable a user to access the training video.

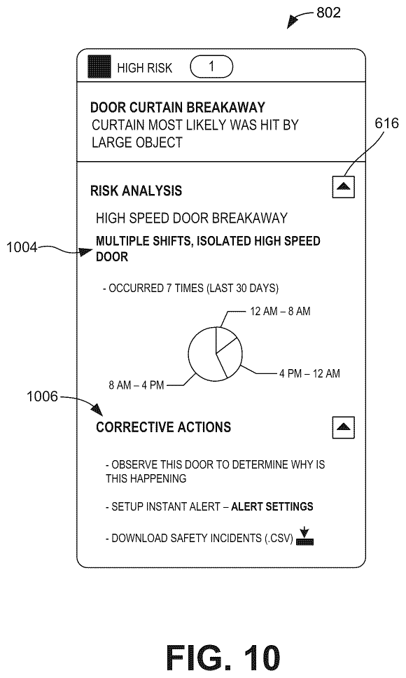

FIG. 10 illustrates the example safety event card 802 of FIG. 8 with the risk analysis dropdown 616 expanded to show the details contained therein. In this example, the risk analysis dropdown 616 includes a location and time summary 1004 that indicates the particular safety event (e.g., a door curtain breakaway) corresponds to multiple blocks of time (e.g., multiple shifts) and a single industrial door. In this situation, there is no indication of the distribution of different instances of the safety event across different locations (e.g., different doors) because all instances of the event occurred at the same door within the relevant reporting period (e.g., the last 30 days). However, the distribution or breakdown or distribution of the different instances across the different shifts is provided. In a similar manner, in examples where a safety event corresponds to the single shift, multiple docks (or doors) scenario, the breakdown or distribution of the shifts may be omitted (because only one shift is involved) while a breakdown or distribution across the different docks (or doors) is provided. Further, as shown in the illustrated example of FIG. 10, different corrective actions 1006 are provided relative to FIG. 9 based on differences in the frequency, location, and time of day of the detected safety events.

FIG. 11 is a block diagram illustrating an example implementation of the example main server 128 of FIG. 1 to aggregate data from various sensors associated with different equipment (e.g., the docks 102 and/or the doors 124) and generate graphical user interfaces (GUIs) based on such aggregated data. The main server 128 of FIG. 11 may be instantiated (e.g., creating an instance of, bring into being for any length of time, materialize, implement, etc.) by processor circuitry such as a central processing unit executing instructions. Additionally or alternatively, the main server 128 of FIG. 11 may be instantiated (e.g., creating an instance of, bring into being for any length of time, materialize, implement, etc.) by an ASIC or an FPGA structured to perform operations corresponding to the Instructions. It should be understood that some or all of the circuitry of FIG. 11 may, thus, be instantiated at the same or different times. Some or all of the circuitry may be instantiated, for example, in one or more threads executing concurrently on hardware and/or in series on hardware. Moreover, in some examples, some or all of the circuitry of FIG. 11 may be implemented by microprocessor circuitry executing instructions to implement one or more virtual machines and/or containers. As shown in FIG. 11, the example main server 128 includes the web server 136. However, as noted above, in some examples, the web server 136 may be implemented separate from the main server 128. Alternatively, the web server 136 may correspond to the main server 128. In other examples, the web server 136 is implemented as software by the main server 128. The example main server 128 as includes, as shown in FIG. 11, example network communications interface circuitry 1102, example IO network interface circuitry 1104, example timestamping circuitry 1106, example data logging circuitry 1108, example sensor feedback analyzing circuitry 1110, example safety event analyzing circuitry 1112, example GUI generating circuitry 1114, and example memory 1116.

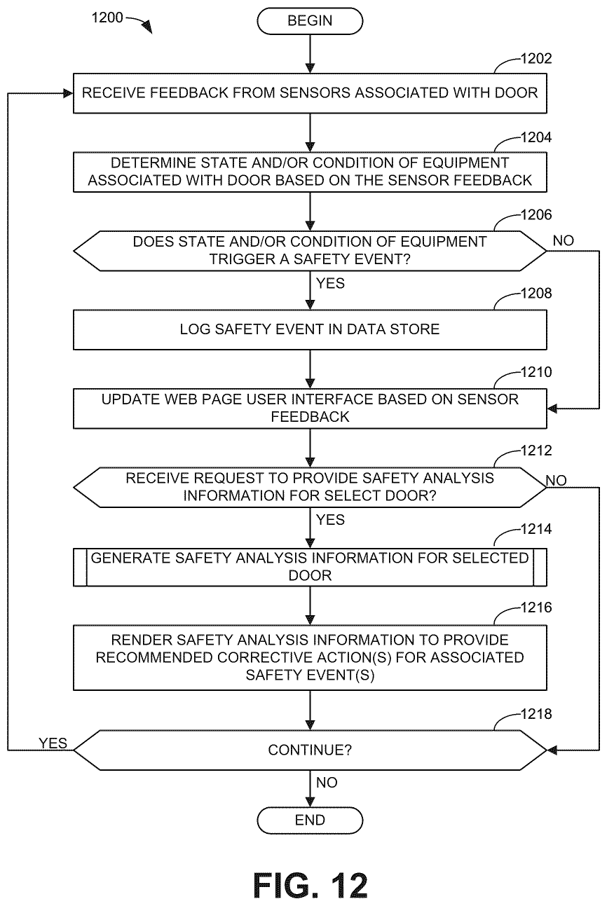

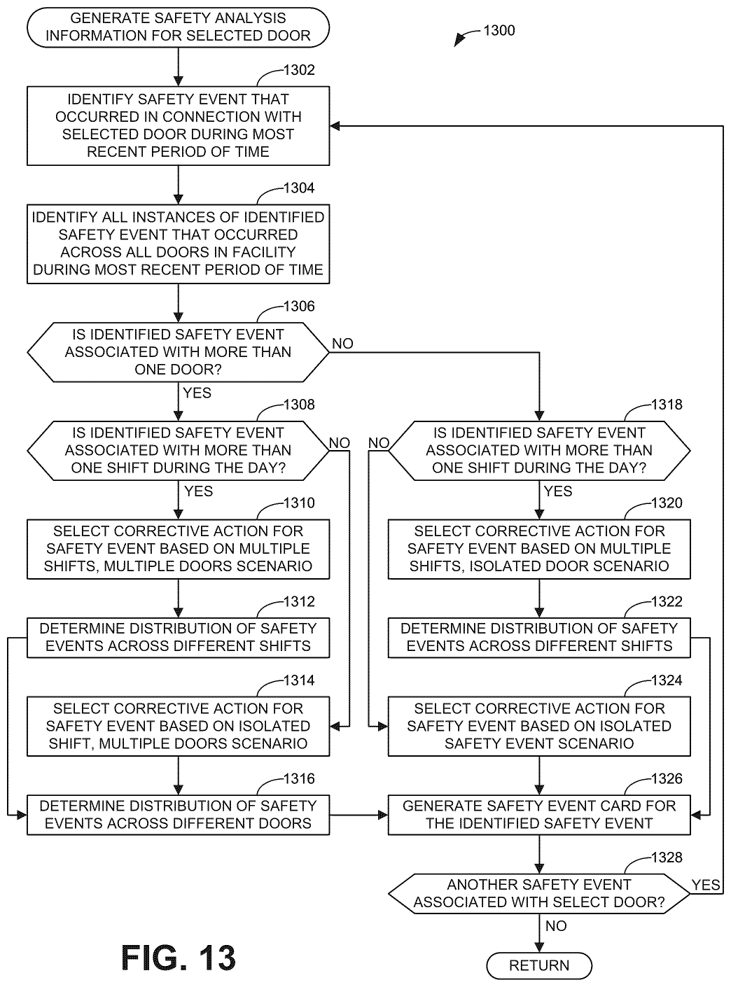

The example network communications interface circuitry 1102 of FIG. 11 enables communications with the client devices 138 independent of the web server 136. For instance, the network communications interface circuitry 1102 may send out email messages and/or SMS messages to one or more client devices 138. Additionally, in some examples, the network communications interface circuitry 1102 may send data to and/or receive data from the local management server(s) 132 and/or the remote server(s) 130. In some examples, data received from the servers 130, 132 is stored in the example memory 1116. In some examples, the network communications interface circuitry 1102 is instantiated by processor circuitry executing network communications interface instructions and/or configured to perform operations such as those represented by the flowchart of FIGS. 12 and 13.

The example IO network interface circuitry 1104 of FIG. 11 enables communications with the dock controllers 116 and the door controllers 126. That is, the IO network interface circuitry 1104 receives sensor feedback data collected by the controllers 116, 126 and/or any other type of IO data reported by the controllers 116, 126. Such data may be aggregated and stored in the memory 1116 for subsequent analysis and/or processing. Additionally or alternatively, in some examples, the IO network interface circuitry 1104 transmits instructions, commands, and/or other types of information to the controllers 116, 126. In some examples, the IO network interface circuitry 1104 is instantiated by processor circuitry executing IO network interface instructions and/or configured to perform operations such as those represented by the flowchart of FIGS. 12 and 13.

The example timestamping circuitry 1106 timestamps sensor feedback data obtained via the IO network interface circuitry 1104 and stores such data in the example memory 1116. In some examples, the sensor feedback data is additionally or alternatively timestamped by the corresponding controller 116, 126 prior to being transmitted to the main server 128. In some examples, the timestamping circuitry 1106 is instantiated by processor circuitry executing timestamping instructions and/or configured to perform operations such as those represented by the flowchart of FIGS. 12 and 13.

The example data logging circuitry 1108 logs the sensor feedback data in the memory 1116 with the associated timestamp provided by the example timestamping circuitry 1106. In some examples, the data logging circuitry 1108 is instantiated by processor circuitry executing data logging instructions and/or configured to perform operations such as those represented by the flowchart of FIGS. 12 and 13. The example sensor feedback analyzing circuitry 1110 analyzes feedback collected from sensors associated with the equipment at the docks 102 and/or the industrial doors 124 to determine the status and/or condition of the equipment and provide suitable commands and/or instructions to the equipment based on the reported status and/or condition of the equipment. Additionally, in some examples, the sensor feedback analyzing circuitry 1110 analyzes and/or compares sensor feedback data aggregated from different dock controllers 116 associated with different docks 102 and/or different door controllers 126 associated with different industrial doors 124. In some examples, the sensor feedback analyzing circuitry 1110 is instantiated by processor circuitry executing sensor feedback analyzing instructions and/or configured to perform operations such as those represented by the flowchart of FIGS. 12 and 13.

The example safety event analyzing circuitry 1112 determines whether the status and/or condition of the equipment (as determined by the sensor feedback analyzing circuitry 1110) is associated with or implicated in any event rules defining the conditions that trigger a safety event. That is, the safety event analyzing circuitry 1112 determines whether the reported status and/or condition of the equipment is the basis for a condition defining the triggering of an event. If the status and/or condition of the equipment is associated with one or more event rules, the safety event analyzing circuitry 1112 evaluates each of the associated event rules based on the newly reported status and/or condition of the equipment to determine whether any safety events have been triggered. In some instances, a particular event rule includes multiple conditions that need to be satisfied before a corresponding safety event is triggered. That is, in some examples, the determination of particular safety events can depend on multiple different pieces of information (e.g., different IO parameters) obtained from multiple different sources (e.g., different sensors and/or other pieces of equipment). If no events have been triggered, no further action is taken. If a safety event is triggered, the example data logging circuitry 1108 logs the event in the memory 1116 with an associated timestamp provided by the example timestamping circuitry 1106.

Once a safety event has been triggered or detected, the example safety event analyzing circuitry 1112 may initiate one or more actions in response to the event. In some examples, one response includes the generation and distribution of a notification to relevant individuals such as the generation of the safety event cards 606, 608, 702, 802, 804 of FIGS. 6-10. In some examples, such notifications include one or more recommended corrective actions to resolve the detected safety event. Accordingly, in some examples, the safety event analyzing circuitry 1112 analyzes the sensor feedback data to select a suitable corrective action. More particularly, in some examples, the safety event analyzing circuitry 1112 identifies all instances or occurrences of a particular type of safety event for a given period. In some examples, the given period corresponds to a most recent period of time. The period of time may be any suitable duration of time (e.g., one day, one week, two weeks, thirty days, one month, etc.). In some examples, the safety event analyzing circuitry 1112 analyzes all instances or occurrences of the particular type of safety event for the given period to determine the total number of such occurrences, a distribution of such occurrences across different locations (e.g., different docks and/or different doors) where such events occurred at least once, and a distribution of such occurrences across different blocks of time during the day (e.g., different shifts during the day). In some examples, the safety event analyzing circuitry 1112 is instantiated by processor circuitry executing safety event analyzing instructions and/or configured to perform operations such as those represented by the flowchart of FIGS. 12 and 13.

The example GUI generating circuitry 1114 of the illustrated example of FIG. 11 generates GUIs (e.g., the GUIs shown in FIGS. 5-10) for display on web pages hosted by the web server 136. In some examples, the GUI generating circuitry 1114 generates GUIs for other apps, applets, applications, etc., accessible by the client device 138 independent of the web server 136. The GUIs generated by the example GUI generating circuitry 1114 may be based on outputs of the sensor feedback analyzing circuitry 1110 and/or the safety event analyzing circuitry 1112. In some examples, the GUI generating circuitry 1114 is instantiated by processor circuitry executing GUI generating instructions and/or configured to perform operations such as those represented by the flowchart of FIGS. 12 and 13.

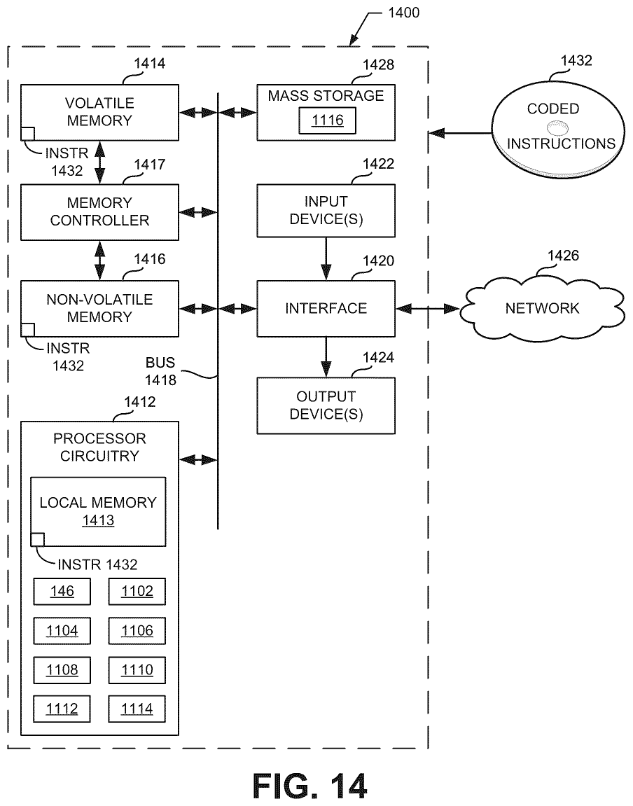

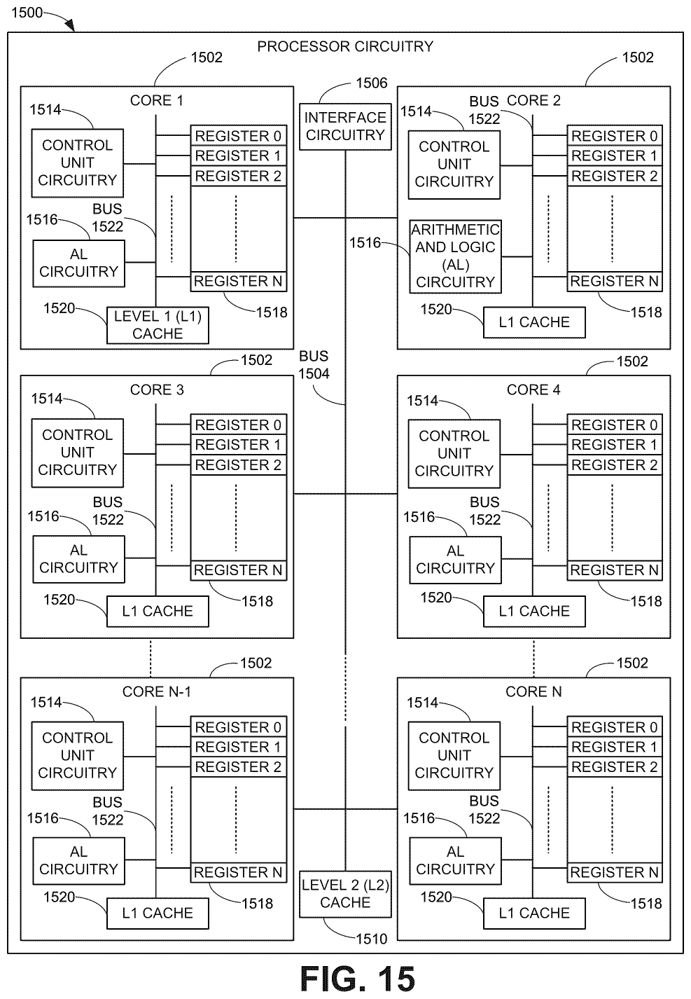

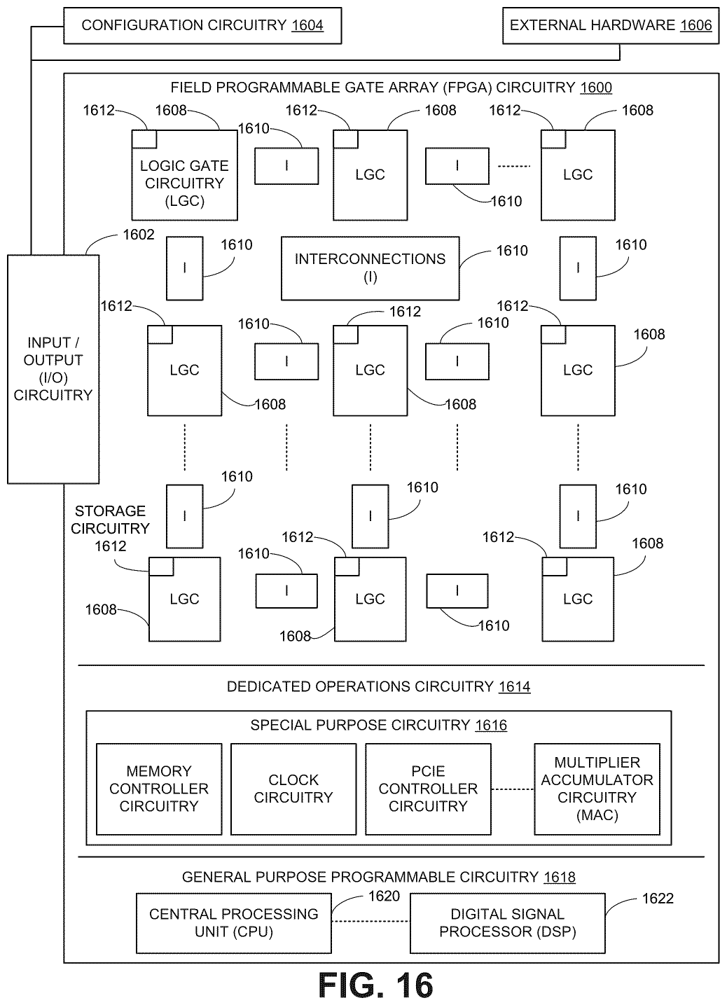

In some examples, the main server 128 includes means for providing a web page. For example, the means for providing a web page may be implemented by the web server 136. In some examples, the web server 136 may be instantiated by processor circuitry such as the example processor circuitry 1412 of FIG. 14. For instance, the web server 136 may be instantiated by the example microprocessor 1500 of FIG. 15 executing associated machine executable instructions. In some examples, the web server 136 may be instantiated by hardware logic circuitry, which may be implemented by an ASIC, XPU, or the FPGA circuitry 1600 of FIG. 16 structured to perform operations corresponding to the machine readable instructions. Additionally or alternatively, the web server 136 may be instantiated by any other combination of hardware, software, and/or firmware. For example, the web server 136 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the main server 128 includes means for communicating with client devices 138. For example, the means for communicating with client device may be implemented by the network communications interface circuitry 1102. In some examples, the network communications interface circuitry 1102 may be instantiated by processor circuitry such as the example processor circuitry 1412 of FIG. 14. For instance, the network communications interface circuitry 1102 may be instantiated by the example microprocessor 1500 of FIG. 15 executing associated machine executable instructions. In some examples, the network communications interface circuitry 1102 may be instantiated by hardware logic circuitry, which may be implemented by an ASIC, XPU, or the FPGA circuitry 1600 of FIG. 16 structured to perform operations corresponding to the machine readable instructions. Additionally or alternatively, the network communications interface circuitry 1102 may be instantiated by any other combination of hardware, software, and/or firmware. For example, the network communications interface circuitry 1102 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the main server 128 includes means for communicating with equipment in the material handling facility 100. For example, the means for communicating may be implemented by the IO network interface circuitry 1104. In some examples, the IO network interface circuitry 1104 may be instantiated by processor circuitry such as the example processor circuitry 1412 of FIG. 14. For instance, the IO network interface circuitry 1104 may be instantiated by the example microprocessor 1500 of FIG. 15 executing machine executable instructions. In some examples, the IO network interface circuitry 1104 may be instantiated by hardware logic circuitry, which may be implemented by an ASIC, XPU, or the FPGA circuitry 1600 of FIG. 16 structured to perform operations corresponding to the machine readable instructions. Additionally or alternatively, the IO network interface circuitry 1104 may be instantiated by any other combination of hardware, software, and/or firmware. For example, the IO network interface circuitry 1104 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the main server 128 includes means for timestamping collected data. For example, the means for timestamping may be implemented by the timestamping circuitry 1106. In some examples, the timestamping circuitry 1106 may be instantiated by processor circuitry such as the example processor circuitry 1412 of FIG. 14. For instance, the network communications interface circuitry 1102 may be instantiated by the example microprocessor 1500 of FIG. 15 executing associated machine executable instructions. In some examples, the timestamping circuitry 1106 may be instantiated by hardware logic circuitry, which may be implemented by an ASIC, XPU, or the FPGA circuitry 1600 of FIG. 16 structured to perform operations corresponding to the machine readable instructions. Additionally or alternatively, the timestamping circuitry 1106 may be instantiated by any other combination of hardware, software, and/or firmware. For example, the timestamping circuitry 1106 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the main server 128 includes means for logging data (e.g., sensor feedback data, safety events, etc.) in a data store (e.g., in the example memory 1116). For example, the means for logging may be implemented by the data logging circuitry 1108. In some examples, the data logging circuitry 1108 may be instantiated by processor circuitry such as the example processor circuitry 1412 of FIG. 14. For instance, the data logging circuitry 1108 may be instantiated by the example microprocessor 1500 of FIG. 15 executing machine executable instructions such as those implemented by at least blocks 1202 and 1208 of FIG. 12. In some examples, the data logging circuitry 1108 may be instantiated by hardware logic circuitry, which may be implemented by an ASIC, XPU, or the FPGA circuitry 1600 of FIG. 16 structured to perform operations corresponding to the machine readable instructions. Additionally or alternatively, the data logging circuitry 1108 may be instantiated by any other combination of hardware, software, and/or firmware. For example, the data logging circuitry 1108 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the main server 128 includes means for analyzing sensor feedback data. For example, the means for analyzing may be implemented by the sensor feedback analyzing circuitry 1110. In some examples, the sensor feedback analyzing circuitry 1110 may be instantiated by processor circuitry such as the example processor circuitry 1412 of FIG. 14. For instance, the sensor feedback analyzing circuitry 1110 may be instantiated by the example microprocessor 1500 of FIG. 15 executing machine executable instructions such as those implemented by at least block 1204 of FIG. 12. In some examples, the sensor feedback analyzing circuitry 1110 may be instantiated by hardware logic circuitry, which may be implemented by an ASIC, XPU, or the FPGA circuitry 1600 of FIG. 16 structured to perform operations corresponding to the machine readable instructions. Additionally or alternatively, the sensor feedback analyzing circuitry 1110 may be instantiated by any other combination of hardware, software, and/or firmware. For example, the sensor feedback analyzing circuitry 1110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the main server 128 includes means for identifying safety events and/or means for determining corrective action(s) for such safety events. For example, the means for identifying safety events, and/or the means for determining corrective action(s) may be implemented by the safety event analyzing circuitry 1112. In some examples, the safety event analyzing circuitry 1112 may be instantiated by processor circuitry such as the example processor circuitry 1412 of FIG. 14. For instance, the safety event analyzing circuitry 1112 may be instantiated by the example microprocessor 1500 of FIG. 15 executing machine executable instructions such as those implemented by at least blocks 1206 and 1212 of FIG. 12 and blocks 1302-1324 of FIG. 13. In some examples, the safety event analyzing circuitry 1112 may be instantiated by hardware logic circuitry, which may be implemented by an ASIC, XPU, or the FPGA circuitry 1600 of FIG. 16 structured to perform operations corresponding to the machine readable instructions. Additionally or alternatively, the safety event analyzing circuitry 1112 may be instantiated by any other combination of hardware, software, and/or firmware. For example, the safety event analyzing circuitry 1112 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the main server 128 includes means for generating a user interface and/or means for providing information to a user. For example, the means for generating and/or means for providing may be implemented by the GUI generating circuitry 1114. In some examples, the GUI generating circuitry 1114 may be instantiated by processor circuitry such as the example processor circuitry 1412 of FIG. 14. For instance, the GUI generating circuitry 1114 may be instantiated by the example microprocessor 1500 of FIG. 15 executing machine executable instructions such as those implemented by at least block 1210 of FIG. 12 and block 1326 of FIG. 13. In some examples, the GUI generating circuitry 1114 may be instantiated by hardware logic circuitry, which may be implemented by an ASIC, XPU, or the FPGA circuitry 1600 of FIG. 16 structured to perform operations corresponding to the machine readable instructions. Additionally or alternatively, the GUI generating circuitry 1114 may be instantiated by any other combination of hardware, software, and/or firmware. For example, the GUI generating circuitry 1114 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the main server 128 includes means for storing data. For example, the means for storing may be implemented by the memory 1116.

While an example manner of implementing the main server 128 of FIG. 1 is illustrated in FIG. 11, one or more of the elements, processes, and/or devices illustrated in FIG. 11 may be combined, divided, re-arranged, omitted, eliminated, and/or implemented in any other way. Further, the example web server 129, the example network communications interface circuitry 1102, the example IO network interface circuitry 1104, the example timestamping circuitry 1106, the example data logging circuitry 1108, the example sensor feedback analyzing circuitry 1110, the example safety event analyzing circuitry 1112, the example GUI generating circuitry 1114, the example memory 1116, and/or, more generally, the example main server 128 of FIG. 1, may be implemented by hardware alone or by hardware in combination with software and/or firmware. Thus, for example, any of the example web server 129, the example network communications interface circuitry 1102, the example IO network interface circuitry 1104, the example timestamping circuitry 1106, the example data logging circuitry 1108, the example sensor feedback analyzing circuitry 1110, the example safety event analyzing circuitry 1112, the example GUI generating circuitry 1114, the example memory 1116, and/or, more generally, the example main server 128, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example main server 128 of FIG. 1 may include one or more elements, processes, and/or devices in addition to, or instead of, those illustrated in FIG. 11, and/or may include more than one of any or all of the illustrated elements, processes and devices.

A flowchart representative of example machine readable instructions, which may be executed to configure processor circuitry to implement the main server 128 of FIG. 11, is shown in FIGS. 12 and 13. The machine readable instructions may be one or more executable programs or portion(s) of an executable program for execution by processor circuitry, such as the processor circuitry 1412 shown in the example processor platform 1400 discussed below in connection with FIG. 14 and/or the example processor circuitry discussed below in connection with FIGS. 15 and/or 16. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowchart illustrated in FIGS. 12 and 13, many other methods of implementing the example main server 128 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 12 and 13 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 12 is a flowchart representative of example machine readable instructions and/or example operations 1200 that may be executed and/or instantiated by processor circuitry to identify safety events in a material handling facility and provide safety analysis information with recommended corrective actions to resolve the safety events. The machine readable instructions and/or the operations 1200 of FIG. 12 begin at block 1202, at which the example IO network interface circuitry 1104 receives feedback from sensors associated with a door. For purposes of explanation, the door referred to in the flowcharts can correspond to an industrial door 121 within the material handling facility 100 or the door 104 at a dock 102 of the material handling facility 100. That is, in the context of the flowcharts, the term “door” can be substituted by the term “dock” and the same logic and process flow would apply. As such, feedback from sensors associated with a door includes feedback from sensors associated with a dock. In some examples, the feedback from the sensors is provided by dock controllers 116 and/or door controllers 126 that collect the feedback data from sensors associated with corresponding docks 102 and/or doors 121.

At block 1204, the example sensor feedback analyzing circuitry 1110 determines the state and/or condition of equipment associated with the door based on the sensor feedback data. At block 1206, the example safety event analyzing circuitry 1112 determines whether the state and/or condition of the equipment triggers a safety event. In some examples, this determination is based on a single IO parameter associated with feedback from a single sensor and/or a single piece of equipment associated with the dock or door. In other examples, the determination of a safety event is based on multiple IO parameters associated with feedback from multiple different sensors and/or pieces of equipment. The number, source, and/or nature of the feedback depends upon the particular conditions defined in an event rule that need to be satisfied before the corresponding safety event is triggered. If so, control advances to block 1208 where the example data logging circuitry 1108 logs the safety event in a data store. Thereafter, control advances to block 1210. Returning to block 1206, if no safety event is triggered, control advances directly to block 1210.

At block 1210, the example GUI generating circuitry 1114 updates a web page user interface based on the sensor feedback data. In some examples, the web page is updated to reflect the current state and/or condition of equipment. Further, in situations where a safety event was triggered, the web page is also updated to reflect the occurrence of the event by, for example, changing the appearance (e.g., color) of a graphic (e.g., dock graphic 502, door graphic 532, etc.) associated with the door where the safety event occurred. In some examples, the GUI generating circuitry 1114 updates any other type of user interface provided to a user (e.g., other than a web page such as an interface for a non-web-based application).

At block 1212, the example safety event analyzing circuitry 1112 determines whether a request to provide safety analysis information for a select door was received (e.g., via the example network communications interface circuitry 1102 and/or via the web server 136). If a request for such information was received, control advances to block 1214 where the main server 128 generates the requested safety analysis information. Further detail regarding the implementation of block 1214 is provided below in connection with FIG. 13. Thereafter, control advances to block 1216 where the example GUI generating circuitry 1114 renders (or causes to be rendered) the safety analysis information to provide recommended corrective action(s) for the associated safety event(s). Control then advances to block 1218. If no request to provide safety analysis information is provided at block 1212, control advances directly to block 1218. At block 1218, the main server 128 determines whether to continue the process. If so, control returns to block 1202. Otherwise, the example process of FIG. 12 ends.

FIG. 13 is a flowchart representative of example machine readable instructions and/or example operations 1300 that may be executed and/or instantiated by processor circuitry to implement block 1214 of FIG. 12. The machine readable instructions and/or the operations 1300 of FIG. 13 begin at block 1302 where the example safety event analyzing circuitry 1112 identifies a safety event that occurred in connection with the selected door (e.g., associated with a dock 102 or an industrial door 121) during a most recent period of time. At block 1304, the example safety event analyzing circuitry 1112 identifies all instances of the identified safety event that occurred across all doors in the material handling facility 100 during the most recent period of time.

At block 1306, the example safety event analyzing circuitry 1112 determines whether the identified safety event is associated with more than one door. If so, control advances to block 1308. In some examples, when a proportion of all instances of the safety event associated with a single door satisfies a relatively large threshold, the example safety event analyzing circuitry 1112 may treat the safety event as being associated with a single door, even if a relatively small proportion of the instances of the safety event occurred in connection with a different door. In other examples, if even one instance of the safety event is associated with a different door than all other instances, the example safety event analyzing circuitry 1112 treats the safety event as being associated with multiple doors (such that control advances to block 1308 as indicated above).

At block 1308, the example safety event analyzing circuitry 1112 determines whether the identified safety event is associated with more than one shift during the day. If so, control advances to block 1310. In some examples, when a proportion of all instances of the safety event associated with a single shift satisfies a relatively large threshold, the example safety event analyzing circuitry 1112 may treat the safety event as being associated with a single shift, even if a relatively small proportion of the instances of the safety event occurred in connection with a different shift. In other examples, if even one instance of the safety event is associated with a different shift than all other instances, the example safety event analyzing circuitry 1112 treats the safety event as being associated with multiple shifts (such that control advances to block 1310 as indicated above). In some examples, different blocks or divisions of time other than shifts in a day may be used.

At block 1310, the example safety event analyzing circuitry 1112 selects a corrective action for the safety event based on a multiple shifts, multiple doors scenario. At block 1312, the example safety event analyzing circuitry 1112 determines a distribution of the different instances or occurrences of the safety event across the different shifts (or other blocks of time). Thereafter, control advances to block 1316 where the example safety event analyzing circuitry 1112 determines a distribution of the different instances or occurrences of the safety event across the different doors (at which at least one instance of the safety event occurred). Thereafter, control advances to block 1326.

Returning to block 1308, if the example safety event analyzing circuitry 1112 determines that the safety event is not associated with more than one shift (i.e., the safety event is only associated with a single shift or a threshold is satisfied to treat the safety event as such), control advances to block 1314. At block 1314, the example safety event analyzing circuitry 1112 selects a corrective action for the safety event based on an isolated shift, multiple doors scenario. Thereafter, control advances to block 1316 to determine the distribution of safety events across the different doors before advancing to block 1326.

Returning to block 1306, if the example safety event analyzing circuitry 1112 determines that the safety event is not associated with more than one door (i.e., the safety event is only associated with a single door or a threshold is satisfied to treat the safety event as such), control advances to block 1318.

At block 1318, the example safety event analyzing circuitry 1112 determines whether the identified safety event is associated with more than one shift during the day. If so, control advances to block 1320. In some examples, when a proportion of all instances of the safety event associated with a single shift satisfies a relatively large threshold, the example safety event analyzing circuitry 1112 may treat the safety event as being associated with a single shift, even if a relatively small proportion of the instances of the safety event occurred in connection with a different shift. In other examples, if even one instance of the safety event is associated with a different shift than all other instances, the example safety event analyzing circuitry 1112 treats the safety event as being associated with multiple shifts (such that control advances to block 1320 as indicated above). In some examples, different blocks or divisions of time other than shifts in a day may be used.

At block 1320, the example safety event analyzing circuitry 1112 selects a corrective action for the safety event based on a multiple shifts, isolated door scenario. At block 1322, the example safety event analyzing circuitry 1112 determines a distribution of the different instances or occurrences of the safety event across the different shifts (or other blocks of time). Thereafter, control advances to block 1326.

Returning to block 1318, if the example safety event analyzing circuitry 1112 determines that the safety event is not associated with more than one shift (i.e., the safety event is only associated with a single shift or a threshold is satisfied to treat the safety event as such), control advances to block 1324. At block 1324, the example safety event analyzing circuitry 1112 selects a corrective action for the safety event based on an isolated safety event scenario. Thereafter, control advances to block 1326.

At block 1326, the example GUI generating circuitry 1114 generates a safety event card for the identified safety event. In some examples, the GUI generating circuitry 1114 generates some other form of notification containing some or all of the content included in the safety event cards discussed above in connection with FIGS. 6-10. At block 1328, the example safety event analyzing circuitry 1112 determines whether there is another safety event (e.g., of a different type) associated with the selected door. If so, control returns to block 1302. Otherwise, the example process of FIG. 12 ends and returns to complete the process of FIG. 12.

In some examples, the request for safety analysis information (at block 1212 of FIG. 12) can be for all doors in the material handling facility 100 instead of simply a select door. In such examples, the implementation of block 1214 of FIG. 12 (as detailed in FIG. 13) is substantially the same as outlined above except that the process is iterated through all identified safety events associated with any door in the material handling facility 100 rather than merely the safety events specifically associated with a particular door selected by a user.

FIG. 14 is a block diagram of an example processor platform 1400 structured to execute and/or instantiate the machine readable instructions and/or the operations of FIGS. 12 and 13 to implement the main server 128 of FIG. 11. The processor platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing device.

The processor platform 1400 of the illustrated example includes processor circuitry 1412. The processor circuitry 1412 of the illustrated example is hardware. For example, the processor circuitry 1412 can be implemented by one or more integrated circuits, logic circuits, FPGAs, microprocessors, CPUs, GPUs, DSPs, and/or microcontrollers from any desired family or manufacturer. The processor circuitry 1412 may be implemented by one or more semiconductor based (e.g., silicon based) devices. In this example, the processor circuitry 1412 implements the example network communications interface circuitry 1102, the example IO network interface circuitry 1104, the example timestamping circuitry 1106, the example data logging circuitry 1108, the example sensor feedback analyzing circuitry 1110, the example safety event analyzing circuitry 1112, and the example GUI generating circuitry 1114.

The processor circuitry 1412 of the illustrated example includes a local memory 1413 (e.g., a cache, registers, etc.). The processor circuitry 1412 of the illustrated example is in communication with a main memory including a volatile memory 1414 and a non-volatile memory 1416 by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417.

The processor platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user to enter data and/or commands into the processor circuitry 1412. The input device(s) 1422 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1400 of the illustrated example also includes one or more mass storage devices 1428 to store software and/or data. Examples of such mass storage devices 1428 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1432, which may be implemented by the machine readable instructions of FIGS. 12 and 13, may be stored in the mass storage device 1428, in the volatile memory 1414, in the non-volatile memory 1416, and/or on a removable non-transitory computer readable storage medium such as a CD or DVD.

FIG. 15 is a block diagram of an example implementation of the processor circuitry 1412 of FIG. 14. In this example, the processor circuitry 1412 of FIG. 14 is implemented by a microprocessor 1500. For example, the microprocessor 1500 may be a general purpose microprocessor (e.g., general purpose microprocessor circuitry). The microprocessor 1500 executes some or all of the machine readable instructions of the flowchart of FIGS. 12 and 13 to effectively instantiate the circuitry of FIG. 11 as logic circuits to perform the operations corresponding to those machine readable instructions. In some such examples, the circuitry of FIG. 11 is instantiated by the hardware circuits of the microprocessor 1500 in combination with the instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowchart of FIGS. 12 and 13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating point operations. In yet other examples, the AL circuitry 1516 may include first AL circuitry that performs integer based operations and second AL circuitry that performs floating point operations. In some examples, the AL circuitry 1516 may be referred to as an Arithmetic Logic Unit (ALU). The registers 1518 are semiconductor-based structures to store data and/or instructions such as results of one or more of the operations performed by the AL circuitry 1516 of the corresponding core 1502. For example, the registers 1518 may include vector register(s), SIMD register(s), general purpose register(s), flag register(s), segment register(s), machine specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure including distributed throughout the core 1502 to shorten access time. The second bus 1522 may be implemented by at least one of an 12C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 16 is a block diagram of another example implementation of the processor circuitry 1412 of FIG. 14. In this example, the processor circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the machine readable instructions in hardware and, thus, can often execute the operations faster than they could be performed by a general purpose microprocessor executing the corresponding software.

More specifically, in contrast to the microprocessor 1500 of FIG. 15 described above (which is a general purpose device that may be programmed to execute some or all of the machine readable instructions represented by the flowchart of FIGS. 12 and 13 but whose interconnections and logic circuitry are fixed once fabricated), the FPGA circuitry 1600 of the example of FIG. 16 includes interconnections and logic circuitry that may be configured and/or interconnected in different ways after fabrication to instantiate, for example, some or all of the machine readable instructions represented by the flowchart of FIGS. 12 and 13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the software represented by the flowchart of FIGS. 12 and 13. As such, the FPGA circuitry 1600 may be structured to effectively instantiate some or all of the machine readable instructions of the flowchart of FIGS. 12 and 13 as dedicated logic circuits to perform the operations corresponding to those software instructions in a dedicated manner analogous to an ASIC. Therefore, the FPGA circuitry 1600 may perform the operations corresponding to the some or all of the machine readable instructions of FIGS. 12 and 13 faster than the general purpose microprocessor can execute the same.

In the example of FIG. 16, the FPGA circuitry 1600 is structured to be programmed (and/or reprogrammed one or more times) by an end user by a hardware description language (HDL) such as Verilog. The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain machine readable instructions to configure the FPGA circuitry 1600, or portion(s) thereof. In some such examples, the configuration circuitry 1604 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1606 may be implemented by external hardware circuitry. For example, the external hardware 1606 may be implemented by the microprocessor 1500 of FIG. 15. The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations that may correspond to at least some of the machine readable instructions of FIGS. 12 and 13 and/or other desired operations. The logic gate circuitry 1608 shown in FIG. 16 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example Dedicated Operations Circuitry 1614. In this example, the Dedicated Operations Circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the processor circuitry 1412 of FIG. 14, many other approaches are contemplated. For example, as mentioned above, modern FPGA circuitry may include an on-board CPU, such as one or more of the example CPU 1620 of FIG. 16. Therefore, the processor circuitry 1412 of FIG. 14 may additionally be implemented by combining the example microprocessor 1500 of FIG. 15 and the example FPGA circuitry 1600 of FIG. 16. In some such hybrid examples, a first portion of the machine readable instructions represented by the flowchart of FIGS. 12 and 13 may be executed by one or more of the cores 1502 of FIG. 15, a second portion of the machine readable instructions represented by the flowchart of FIGS. 12 and 13 may be executed by the FPGA circuitry 1600 of FIG. 16, and/or a third portion of the machine readable instructions represented by the flowchart of FIGS. 12 and 13 may be executed by an ASIC. It should be understood that some or all of the circuitry of FIG. 11 may, thus, be instantiated at the same or different times. Some or all of the circuitry may be instantiated, for example, in one or more threads executing concurrently and/or in series. Moreover, in some examples, some or all of the circuitry of FIG. 11 may be implemented within one or more virtual machines and/or containers executing on the microprocessor.

In some examples, the processor circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the processor circuitry 1412 of FIG. 14, which may be in one or more packages. For example, the XPU may include a CPU in one package, a DSP in another package, a GPU in yet another package, and an FPGA in still yet another package.

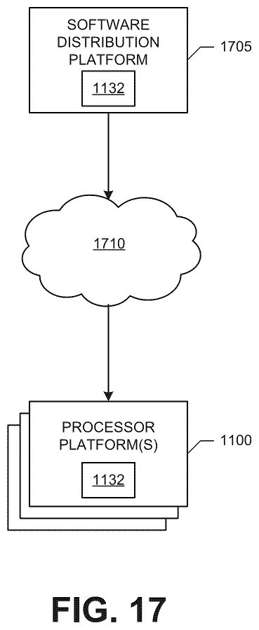

A block diagram illustrating an example software distribution platform 1705 to distribute software such as the example machine readable instructions 1132 of FIG. 14 to hardware devices owned and/or operated by third parties is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1132 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1132, which may correspond to the example machine readable instructions 1200, 1300 of FIGS. 12 and 13, as described above. The one or more servers of the example software distribution platform 1705 are in communication with an example network 1710, which may correspond to any one or more of the Internet and/or any of the example networks 1426 described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine readable instructions 1132 from the software distribution platform 1705. For example, the software, which may correspond to the example machine readable instructions 1200, 1300 of FIGS. 12 and 13, may be downloaded to the example processor platform 1400, which is to execute the machine readable instructions 1132 to implement the main server 128. In some examples, one or more servers of the software distribution platform 1705 periodically offer, transmit, and/or force updates to the software (e.g., the example machine readable instructions 1132 of FIG. 14) to ensure improvements, patches, updates, etc., are distributed and applied to the software at the end user devices.

From the foregoing, it will be appreciated that example methods, apparatus, and articles of manufacture have been disclosed that enable the aggregation and integration of data from disparate controllers, sensors, etc. within a material handling facility for subsequent analysis to generate notifications and/or provide outputs via web page (or other application) interfaces that update in substantially real time. Examples disclosed herein improve the efficiency of using electronic devices for monitoring a material handling facility by bringing together the disparate information in a consolidated manner, thereby avoiding redundancies from monitoring multiple isolated systems. Furthermore, the combination of information gathered from different sources enables users to access and/or be made aware of particular circumstances that were not previously possible to detect in an automatic fashion such as, for example, nature and context of particular safety events relative to the occurrence of other instances of the particular safety events at other locations and/or at other times of the day. More particularly, examples disclosed herein categorize safety events into one of four scenarios based on whether all instances of event in a given period are associated with a single location (e.g., a single dock or single door) or multiple locations and based on whether the event is associated with a single block of time in a day (e.g., a single shift of work) or multiple blocks of time in the day. Categorizing all instances of events in this manner enables the selection of tailored recommendations for corrective actions that are responsive to the particular nature of the event for more efficient and/or effective resolution of such events. Tracking all instances at disparate locations at different times over an extended period of time cannot practically be performed in the human mind and that provides significant and practical improvements to the operation of a material handling facility based on improved efficiencies in the use and/or operation of a computing device. Disclosed systems, methods, apparatus, and articles of manufacture are accordingly directed to one or more improvement(s) in the operation of a machine such as a computer or other electronic and/or mechanical device.

Further examples and combinations thereof include the following:

Example 1 includes an apparatus comprising at least one memory, machine readable instructions, and processor circuitry to at least one of instantiate or execute the machine readable instructions to identify a first occurrence of a safety event based on outputs of sensors associated with at least one of doors or docks at a material handling facility, the event associated with a first event type of a plurality of event types, determine a time of day different instances of the event occurred within a given period of time, determine a number of at least one of different doors or different docks associated with the different instances of the event, select a particular corrective action from among a set of possible corrective actions based on the time of day of the different instances of the event and based on the number of the at least one of the different doors or the different docks, and cause an output device to output an indication of the particular corrective action to a user.

Example 2 includes the apparatus of example 1, wherein a first one of the doors is located at a first one of the docks of the material handling facility at which a trailer is to be positioned for loading or unloading, and a second one of the doors is an industrial door that separates two areas within the material handling facility.

Example 3 includes the apparatus of any one of examples 1 or 2, wherein a first one of the docks includes at least one of a vehicle restraint, a dock leveler, a presence/motion detector, a notification system, or a doorway barrier.

Example 4 includes the apparatus of any one of examples 1 or 3, wherein the processor circuitry is to determine a proportion of all the different instances of the event that are associated with a first one of the at least one of the doors or the docks, the particular corrective action corresponding to a first one of the corrective actions when the proportion satisfies a threshold, the particular corrective action corresponding to a second one of the corrective actions when the proportion does not satisfy the threshold, the second corrective action different than the first corrective action.

Example 5 includes the apparatus of example 4, wherein the threshold corresponds to all of the different occurrences such that all of the different instances of the event are associated with the first one of the at least one of the doors or the docks.

Example 6 includes the apparatus of any one of examples 4 or 5, wherein the processor circuitry is to, in response to a determination that the proportion does not satisfy the threshold, provide a representation of a distribution of a number of the different instances of the event associated with different ones of the at least one of the doors or the docks.

Example 7 includes the apparatus of any one of examples 4-6, wherein the proportion is a first proportion, the processor circuitry to determine a second proportion of all the different instances of the event that occurred during a first block of a plurality of blocks of time during a day, the first corrective action corresponding to a third one of the corrective actions when the second proportion satisfies a threshold, the first corrective action corresponding to a fourth one of the corrective actions when the second proportion does not satisfy the threshold, the third corrective action different than the fourth corrective action.

Example 8 includes the apparatus of any one of examples 1-7, wherein the processor circuitry is to associate different ones of the different instances of the event with different blocks of time during a day based on the time of day of the different ones of the different instances of the event, and determine the particular corrective action based on a distribution of the different instances of the event across the different blocks of time.

Example 9 includes the apparatus of example 8, wherein the processor circuitry is to provide a representation of the distribution along with the particular corrective action.

Example 10 includes the apparatus of any one of examples 8 or 9, wherein the different blocks of time correspond to different shifts of personnel at the material handling facility.

Example 11 includes the apparatus of any one of examples 8-10, wherein the processor circuitry is to determine a number of different ones of the at least one of the doors or the docks associated with at least one of the different instances of the event that are associated with a first one of the at least one of the doors or the docks, and determine the particular corrective action based on the number of the different ones of the at least one of the doors or the docks.

Example 12 includes at least one non-transitory computer readable medium comprising instructions that, when executed, cause processor circuitry to at least identify a first occurrence of a safety event based on outputs of sensors associated with at least one of doors or docks at a material handling facility, the event associated with a first event type of a plurality of event types, determine a time of day different instances of the event occurred within a given period of time, determine a number of at least one of different doors or different docks associated with the different instances of the event, select a particular corrective action from among a set of possible corrective actions based on the time of day of the different instances of the event and based on the number of the at least one of the different doors or the different docks, and cause an output device to output an indication of the particular corrective action to a user.

Example 13 includes the at least one non-transitory computer readable medium of example 12, wherein a first one of the doors is located at a first one of the docks of the material handling facility at which a trailer is to be positioned for loading or unloading, and a second one of the doors is an industrial door that separates two areas within the material handling facility.

Example 14 includes the at least one non-transitory computer readable medium of any one of examples 12 or 13, wherein a first one of the docks includes at least one of a vehicle restraint, a dock leveler, a presence/motion detector, a notification system, or a doorway barrier.

Example 15 includes the at least one non-transitory computer readable medium of any one of examples 12-14, wherein the instructions cause the processor circuitry to determine a proportion of all the different instances of the event that are associated with a first one of the at least one of the doors or the docks, the particular corrective action corresponding to a first one of the corrective actions when the proportion satisfies a threshold, the particular corrective action corresponding to a second one of the corrective actions when the proportion does not satisfy the threshold, the second corrective action different than the first corrective action.

Example 16 includes the at least one non-transitory computer readable medium of example 15, wherein the threshold corresponds to all of the different occurrences such that all of the different instances of the event are associated with the first one of the at least one of the doors or the docks.

Example 17 includes the at least one non-transitory computer readable medium of any one of examples 15 or 16, wherein the instructions cause the processor circuitry to, in response to a determination that the proportion does not satisfy the threshold, provide a representation of a distribution of a number of the different instances of the event associated with different ones of the at least one of the doors or the docks.

Example 18 includes the at least one non-transitory computer readable medium of any one of examples 15-17, wherein the proportion is a first proportion, the instructions to cause the processor circuitry to determine a second proportion of all the different instances of the event that occurred during a first block of a plurality of blocks of time during a day, the first corrective action corresponding to a third one of the corrective actions when the second proportion satisfies a threshold, the first corrective action corresponding to a fourth one of the corrective actions when the second proportion does not satisfy the threshold, the third corrective action different than the fourth corrective action.

Example 19 includes the at least one non-transitory computer readable medium of any one of examples 12-18, wherein the instructions cause the processor circuitry to associate different ones of the different instances of the event with different blocks of time during a day based on the time of day of the different ones of the different instances of the event, and determine the particular corrective action based on a distribution of the different instances of the event across the different blocks of time.

Example 20 includes the at least one non-transitory computer readable medium of example 19, wherein the instructions cause the processor circuitry to provide a representation of the distribution along with the particular corrective action.

Example 21 includes the at least one non-transitory computer readable medium of any one of examples 19 or 20, wherein the different blocks of time correspond to different shifts of personnel at the material handling facility.

Example 22 includes the at least one non-transitory computer readable medium of any one of examples 19-21, wherein the instructions cause the processor circuitry to determine a number of different ones of the at least one of the doors or the docks associated with at least one of the different instances of the event that are associated with a first one of the at least one of the doors or the docks, and determine the particular corrective action based on the number of the different ones of the at least one of the doors or the docks.

Example 23 includes a method comprising identifying a first occurrence of a safety event based on outputs of sensors associated with at least one of doors or docks at a material handling facility, the event associated with a first event type of a plurality of event types, determining a time of day different instances of the event occurred within a given period of time, determining a number of at least one of different doors or different docks associated with the different instances of the event, selecting, by executing an instruction with processor circuitry, a particular corrective action from among a set of possible corrective actions based on the time of day of the different instances of the event and based on the number of the at least one of the different doors or the different docks, and causing an output device to output an indication of the particular corrective action to a user.

Example 24 includes the method of example 23, wherein a first one of the doors is located at a first one of the docks of the material handling facility at which a trailer is to be positioned for loading or unloading, and a second one of the doors is an industrial door that separates two areas within the material handling facility.

Example 25 includes the method of any one of examples 23 or 34, wherein a first one of the docks includes at least one of a vehicle restraint, a dock leveler, a presence/motion detector, a notification system, or a doorway barrier.

Example 26 includes the method of any one of examples 23-25, further including determining a proportion of all the different instances of the event that are associated with a first one of the at least one of the doors or the docks, the particular corrective action corresponding to a first one of the corrective actions when the proportion satisfies a threshold, the particular corrective action corresponding to a second one of the corrective actions when the proportion does not satisfy the threshold, the second corrective action different than the first corrective action.

Example 27 includes the method of example 26, wherein the threshold corresponds to all of the different occurrences such that all of the different instances of the event are associated with the first one of the at least one of the doors or the docks.

Example 28 includes the method of any one of examples 26 or 27, further including, in response to a determination that the proportion does not satisfy the threshold, providing a representation of a distribution of a number of the different instances of the event associated with different ones of the at least one of the doors or the docks.

Example 29 includes the method of any one of examples 26-28, wherein the proportion is a first proportion, the method further including determining a second proportion of all the different instances of the event that occurred during a first block of a plurality of blocks of time during a day, the first corrective action corresponding to a third one of the corrective actions when the second proportion satisfies a threshold, the first corrective action corresponding to a fourth one of the corrective actions when the second proportion does not satisfy the threshold, the third corrective action different than the fourth corrective action.

Example 30 includes the method of any one of examples 23-29, further including associating different ones of the different instances of the event with different blocks of time during a day based on the time of day of the different ones of the different instances of the event, and determining the particular corrective action based on a distribution of the different instances of the event across the different blocks of time.

Example 31 includes the method of example 30, further including providing a representation of the distribution along with the particular corrective action.

Example 32 includes the method of any one of examples 30 or 31, wherein the different blocks of time correspond to different shifts of personnel at the material handling facility.

Example 33 includes the method of any one of examples 30-32, further including determining a number of different ones of the at least one of the doors or the docks associated with at least one of the different instances of the event that are associated with a first one of the at least one of the doors or the docks, and determining the particular corrective action based on the number of the different ones of the at least one of the doors or the docks.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
at least one memory;
machine readable instructions; and
processor circuitry to at least one of instantiate or execute the machine readable instructions to:
identify a first occurrence of a safety event based on outputs of sensors associated with at least one of doors or docks at a material handling facility, the event associated with a first event type of a plurality of event types;
determine a time of day different instances of the event occurred within a given period of time;
determine a number of at least one of different doors or different docks associated with the different instances of the event;
select a particular corrective action from among a set of possible corrective actions based on the time of day of the different instances of the event and based on the number of the at least one of the different doors or the different docks; and
cause an output device to output an indication of the particular corrective action to a user.

2. The apparatus of claim 1, wherein a first one of the doors is located at a first one of the docks of the material handling facility at which a trailer is to be positioned for loading or unloading, and a second one of the doors is an industrial door that separates two areas within the material handling facility.

3. The apparatus of claim 1, wherein a first one of the docks includes at least one of a vehicle restraint, a dock leveler, a presence/motion detector, a notification system, or a doorway barrier.

4. The apparatus of claim 1, wherein the processor circuitry is to determine a proportion of all the different instances of the event that are associated with a first one of the at least one of the doors or the docks, the particular corrective action corresponding to a first one of the corrective actions when the proportion satisfies a threshold, the particular corrective action corresponding to a second one of the corrective actions when the proportion does not satisfy the threshold, the second corrective action different than the first corrective action.

5. The apparatus of claim 4, wherein the threshold corresponds to all of the different instances such that all of the different instances of the event are associated with the first one of the at least one of the doors or the docks.

6. The apparatus of claim 4, wherein the processor circuitry is to, in response to a determination that the proportion does not satisfy the threshold, provide a representation of a distribution of a number of the different instances of the event associated with different ones of the at least one of the doors or the docks.

7. The apparatus of claim 4, wherein the proportion is a first proportion, the processor circuitry to determine a second proportion of all the different instances of the event that occurred during a first block of a plurality of blocks of time during a day, the first corrective action corresponding to a third one of the corrective actions when the second proportion satisfies a threshold, the first corrective action corresponding to a fourth one of the corrective actions when the second proportion does not satisfy the threshold, the third corrective action different than the fourth corrective action.

8. The apparatus of claim 1, wherein the processor circuitry is to:
associate different ones of the different instances of the event with different blocks of time during a day based on the time of day of the different ones of the different instances of the event; and
determine the particular corrective action based on a distribution of the different instances of the event across the different blocks of time.

9. The apparatus of claim 8, wherein the processor circuitry is to provide a representation of the distribution along with the particular corrective action.

10. The apparatus of claim 8, wherein the different blocks of time correspond to different shifts of personnel at the material handling facility.

11. The apparatus of claim 8, wherein the processor circuitry is to:
determine a number of different ones of the at least one of the doors or the docks associated with at least one of the different instances of the event that are associated with a first one of the at least one of the doors or the docks; and
determine the particular corrective action based on the number of the different ones of the at least one of the doors or the docks.

12. At least one non-transitory computer readable medium comprising instructions that, when executed, cause processor circuitry to at least:
identify a first occurrence of a safety event based on outputs of sensors associated with at least one of doors or docks at a material handling facility, the event associated with a first event type of a plurality of event types;
determine a time of day different instances of the event occurred within a given period of time;
determine a number of at least one of different doors or different docks associated with the different instances of the event;
select a particular corrective action from among a set of possible corrective actions based on the time of day of the different instances of the event and based on the number of the at least one of the different doors or the different docks; and
cause an output device to output an indication of the particular corrective action to a user.

13. The at least one non-transitory computer readable medium of claim 12, wherein a first one of the doors is located at a first one of the docks of the material handling facility at which a trailer is to be positioned for loading or unloading, and a second one of the doors is an industrial door that separates two areas within the material handling facility.

14. The at least one non-transitory computer readable medium of claim 12, wherein a first one of the docks includes at least one of a vehicle restraint, a dock leveler, a presence/motion detector, a notification system, or a doorway barrier.

15. The at least one non-transitory computer readable medium of claim 12, wherein the instructions cause the processor circuitry to determine a proportion of all the different instances of the event that are associated with a first one of the at least one of the doors or the docks, the particular corrective action corresponding to a first one of the corrective actions when the proportion satisfies a threshold, the particular corrective action corresponding to a second one of the corrective actions when the proportion does not satisfy the threshold, the second corrective action different than the first corrective action.

16-18. (canceled)

19. The at least one non-transitory computer readable medium of claim 12, wherein the instructions cause the processor circuitry to:
associate different ones of the different instances of the event with different blocks of time during a day based on the time of day of the different ones of the different instances of the event; and
determine the particular corrective action based on a distribution of the different instances of the event across the different blocks of time.

20-22. (canceled)

23. A method comprising:
identifying a first occurrence of a safety event based on outputs of sensors associated with at least one of doors or docks at a material handling facility, the event associated with a first event type of a plurality of event types;
determining a time of day different instances of the event occurred within a given period of time;
determining a number of at least one of different doors or different docks associated with the different instances of the event;
selecting, by executing an instruction with processor circuitry, a particular corrective action from among a set of possible corrective actions based on the time of day of the different instances of the event and based on the number of the at least one of the different doors or the different docks; and
causing an output device to output an indication of the particular corrective action to a user.

24. The method of claim 23, wherein a first one of the doors is located at a first one of the docks of the material handling facility at which a trailer is to be positioned for loading or unloading, and a second one of the doors is an industrial door that separates two areas within the material handling facility.

25. The method of claim 23, wherein a first one of the docks includes at least one of a vehicle restraint, a dock leveler, a presence/motion detector, a notification system, or a doorway barrier.

26. The method of claim 23, further including determining a proportion of all the different instances of the event that are associated with a first one of the at least one of the doors or the docks, the particular corrective action corresponding to a first one of the corrective actions when the proportion satisfies a threshold, the particular corrective action corresponding to a second one of the corrective actions when the proportion does not satisfy the threshold, the second corrective action different than the first corrective action.

27-33. (canceled)
